(19) United States
(12) Patent Application Publication
(10) Pub. No.: US 2018/0018719 A1
(43) Pub. Date: Jan. 18, 2018

(54) QUALITY PERCEPTION INFORMATION MANAGEMENT METHOD AND SYSTEM BASED ON THREE-DIMENSIONAL EVALUATION AND TIME DOMAIN TRACING

(71) Applicant: Shuhuai CAO, Xiamen (CN)

(72) Inventor: Shuhuai CAO, Xiamen (CN)

(21) Appl. No.: 15/611,606

(22) Filed: Jun. 1, 2017

Related U.S. Application Data
(63) Continuation of application No. PCT/CN2015/083831, filed on Dec. 7, 2015.

(30) Foreign Application Priority Data
Dec. 1, 2014 (CN) 201410628607.4

(51) Int. Cl. G06Q 30/02; G06Q 30/00; G06F 17/30

(52) U.S. Cl. CPC G06Q 30/0282; G06Q 30/0283; G06F 17/30286; G06Q 30/018; G06Q 30/0201

(57) ABSTRACT

The present invention relates to the quality management field and the informatization field, wherein the quality management field refers to quality management for products or services of the whole industrial level in links of research and development, manufacturing, circulation and consumption, as well as quality evaluation and quality perception management of consumers or stakeholders on the products or the services, and the main quality management technologies and standards are described as follows: a three-level quality management theory, a VDA (Verband der Automobilindustrie) series standard, quality evaluation or quality perception measurement, language expression and quality parameter detection or monitoring; and the informatization field refers to collection, traceability acquisition, storage, analysis, detection, mining, early-warning, transmission and utilization of quality evaluation/perception information, and a mass data processing technology in an informatization process.

### TECHNICAL FIELD

The present invention relates to the quality management field and the informatization field, wherein the quality management field refers to quality management for products or services of the whole industrial level in links of research and development, manufacturing, circulation and consumption, as well as quality evaluation and quality perception management of consumers or stakeholders on the products or the services, and the main quality management technologies and standards are described as follows: a three-level quality management theory, a VDA (Verband der Automobilindustrie) series standard, quality evaluation or quality perception measurement, language expression and quality parameter detection or monitoring; and the informatization field refers to collection, traceability acquisition, storage, analysis, detection, mining early-warning, transmission and utilization of quality evaluation/perception information, and a mass data processing technology in an informatization process, and the main information technologies are described as follows GIS (Geographic Information System) geographic information technology, a mobile communication technology, an intelligent detection sensor technology and a computer technology, in particular to a database technology (mass data graphical acquisition, storage, searching and analysis technologies, big data parallel computation and analysis technologies and graphical information identification and display technologies).

### BACKGROUND

A product quality evaluation is in a product value provider for a long time, and the product quality evaluation and information perception of most consumers have the following features existing for a long time: lack of a right to know (perception equality and fairness), difficulty in acquisition (perception acquisition) and difficulty in understanding (perception facilitation), thereby determining that the consumers play the role of benefit victims of products for a long time to a great extent.

Product quality information and fairness, integrity and accuracy of judgment for the product quality information are questioned by all sectors of the community all the time, and the problem is solved by aa. comprehensive method and system under the background of mass data of a mobile interact is the core purpose of the patent.

For the benefit point of a product quality value, the product value provider and the consumers are in the contrary sides to a great extent, the traditional quality management obtains more protection from supervision and management of a third party (such as a shareholder of the product value provider, a justice institution or a government), and the protection depends on the game point of macrocosmic benefit to a great extent. Therefore, from the benefit as the starting point, any unilateral quality evaluation cannot give an objective and fair evaluation on a negative value of defective products definitely and reasonably

In view of a single object, the applicability of product quality is doubly influenced by a subjective condition and an external environment tan objective condition) of the consumers, the supply commitment of the product value provider is also doubly influenced by individual demands and own subjective/objective conditions, the interaction between the consumers and the product value provider is balanced in a fluctuation manner under double changes of time and geographies, and how to obtain an optimal balance under the dynamic changes of the consumers, the value provider and a time domain is a triggering point of the present invention and innovation.

Macroscopically, the product quality evaluation of the consumers depends on perception of individuals on objects to a greater extent, and the perception of people on specifications of the objects existing objectively refers to an interaction process that an objective world proves a subject world, and the subject world responds to the objective world, thereby realizing capture and application of interaction information, which has a great value for human development.

At present, a GIS technology, a mobile interne communication technology, a mass data computation and analysis technology and an intelligent detection sensor technology are developed rapidly, which has a strong technical supporting action and a promotion and application basis for quality perception information management. The quality perception information can be realized by constructing a traceability mass data management mode, thereby having great application prospect and practical value.

### SUMMARY

0-1: an exemplary embodiment refers to a case that an individual realizes dynamic management for hardness perception information of steamed breads under time domain tracing, (a case A: ET (Easy-Traceability) quality perception process for short), and an ET system involved in the case summarizes all contents or part of the contents of the present invention.

Case A: ET Quality Perception Process

An ET quality perception process is a process and method of information acquisition, recording, analysis and tracing, for example:

an 18-year-old girl A perceives that. the hardness of a steamed bread C (which is produced by a production line o of a factory i (longitude NS: XX, latitude: YY) at 02:34:45 on Sep. 12, 2014) is extremely good and thinks that it is necessary to trigger an evaluation at the eating moment when the girl eats the steamed bread with a handsome boy who is loved at the first sight by the girl in a blind date in a restaurant a (latitude NS: xx, longitude WE: yy, global chain operation) at 08:00:45 (Beijing time) on Oct. 24, 2014, and an Ih (Infliction Host) is generated in a model when the ET system acquires triggering information. The girl A generates a perception when the girl eats the steamed bread. C with the first love at 18 years old that: ‘the steamed bread C is really as hard as granite’ when the girl A eats a ‘no-chewing steamed bread C′’ in a restaurant at 80 years old at 08:00:45 (Beijing time) on May 27, 2078. At this moment, the girl triggers an evaluation on the steamed bread C, another is generated in the model when the ET system acquires triggering information, the Ih is triggered due to the steamed bread C′, and an Rh (Receive Host) is the steamed bread C. It can be imagined that, the Ih in the ET system defines a perception of people on some specific object generated whenever and wherever under various environments. A traceability Ih is generated when the perception is triggered.

It perhaps has no value to research the hardness of the steamed bread C, however, it might be assumed that, the ET system also acquires an Ih for a steamed bread C@ (at a same gene axis) of the first love (the 80-year-old husband) of the A, the first love perceives that ‘the steamed bread is too hard’ when eating the steamed bread in the first love, while the first love feels that ‘the hardness of the steamed bread is OK’ now; it might be assumed that, 50,000,000 evaluate axes of the gene axis are acquired in the ET system, the evaluate axes are distributed at nearby regions, it is discovered that, most of the type of evaluation main bodies trigger an Ea (evaluate axis) for a gene axis of ‘service attitude of marriage counseling station of Civil Affairs Bureau’, so whether it can be concluded that the marital happiness tendency of the A descends or the marital happiness tendency of the husband of the A ascends, and whether it can be concluded that the perception on the hardness of the steamed bread of a person reflects the marital happiness tendency of the person in some probability.

There may be many reviews on the case, and even it is considered that some conclusions are idealistic. However, there is no evidence to overturn the relation of the conclusions according to objective and reliable reasoning reviews. When a relation of objects is reviewed, the conclusion ‘yes’ cannot be overturned if there is no an objective evidence to prove ‘no’. A general opinion is that, the A does not have teeth at 80 years old, so the A naturally feels that the steamed bread eaten 62 years ago ‘becomes hard’, however, when about 5,000,000 evaluations approximate to an Ea of ‘the steamed bread becomes soft’ (a hardness Ea made after 62 years for the steamed bread (having a same PgA@ (Perception gene Axis)) made in the same process and eaten in that same restaurant 62 years ago) are researched in the ET system, the above reasoning seems to be more convictive.

What makes the objectively existing perception of people on ‘the hardness of the steamed bread 62 years ago’ change invariably is also the value of existence of a traceability technology. The perception of people on the hardness is changed? Whether the memory and perception of human are influenced by the living environment of human? How to assist to analyze that a person lack of teeth recalls the hardness perception (compared with the original perception, does the steamed bread become hard or soft?) when die person having the teeth eats the steamed bread is also a subject worth being studied and is also one of the values of existence of the ET system.

Relative materials describe that the perception is ‘ephemeras’ in the memory of human and the ‘ephemerality’ and the ‘inseparability of the process’ are one difficulty in promoting the management level in the service industry. However, it is not considered like that in the ET system, at least, the common character of the tendency of the perception is ‘easy-traceability’, which is attributed to the probability of occurrence of the objects and the common tendency of the perceptions of human on the objects.

Under the principle of enough number of samples, whether most unsolved mysteries can be explained by the similar perceptions of human on the objects? The perceptions of human on some object reflect a wisdom, and the wisdom is a set of knowledge, experience and instinct reaction. The ET system captures the common perceptions, obtains tendency, understands past, seizes the day and serves for the human development, so that everything becomes better.

With regard to that how the ET system achieves the expected effect, back to the case A. values of information processing and analyzing of the ET system are concluded again:

The system detects that the A generally feels that the hardness is OK at about 40 years old when the A eats the steamed bread in any of chain restaurants a (the A thinks that the ET system gives great help for the life of the A, an ET evaluation made every time represents the real evaluation of the A, and actually, the ET system can detects the authenticity of evaluation information or the credibility and the application significance of the evaluation information by a time domain and a collaborative analysis); in addition, from a perception linking ET axis, it is discovered that, B constantly triggers a PgA (original perception gene axis) at about 20 years old (in about 2036) within the range of the University of EiFO, at the same time, the ET system discovers that a gene axis of ‘the steamed bread is too hard’ triggered by the AS in 2034 according to an ‘assistant ET axis’ (an ‘ET information analysis system’ integrates an ‘Ih’ and an ‘Ih’ of the model under the ‘Ih’ of the PgA (a gene axis of the steamed bread is eaten at 18 years old.), and the model of the gene axis keeps unchanged.) and obtains a replay of the restaurant a, and in the model of the gene axis triggered by the restaurant a, the system can see a ‘process domain’ of making the steamed bread of the restaurant a; from 2014 to 2036, except that a steamed bread maker jack leaves office after handing over the work to the son Alike, other making materials, equipment, environment, a making process and instrument equipment for measuring taste are not questionably changed, the accuracy of the measurement equipment is traced back to the international standard (calibrated by a third-party laboratory) in every quarter, and the quality chief inspector of the restaurant a firmly thinks that even if the random probability that the A eats a hard steamed bread exists, the probability is very little. In the PgA initiated by the A, the ET system discovers that, the A makes an evaluation that ‘actually, compared with the current steamed bread, that steamed bread is a little harder indeed,’ for the ‘Rh’ (that steamed bread chewed at the 18 years old) of the model of the PgA in some day of May, 2034, at the same time, the ET system detects that the A initiates many gene axes for edible salt issued by the ‘Welfare Guarantee Institution of the Community’ ‘gets damp all the time’ from 2014 to 2034, and A initiates a gene axis of ‘so bad service attitude’ of staffs of the ‘National Student Loan. Institution’ in 2035. Based on the traced information for the A, an ET information platform sends decision information that ‘A and B have a mother-child relationship’ and ‘the son goes to the university and the mother eats well’, the ET information analysis system traces two decision information in the reverse direction, and the ET information analysis system traces information such as ‘the university campus is too beautiful’, ‘the letter of admission is very nice’, ‘the enrolment rate of the senior high school in Huangxi district’ and the like for the second decision information, traces and searches the evaluation main bodies of the ‘perception linking ET axis’ for the type of 5,000,000 valuators and discovers that the mother of the traced main bodied has the same feeling indeed; through sufficient mining for the information, it is discovered that the geographies of 100,000 evaluation main bodies are abroad; in the evaluations of the 100,000 persons for the gene axis of ‘the son goes to the university, and the mother is very happy’, only 18 persons feel very happy; and through the mining for evaluation information of residual 4,900,000 Chinese mothers, it is discovered that 900,000 persons have evaluations that ‘the son goes to the university, and the mother is very happy’, and only seven persons do not have the evaluation. Therefore, the system obtains decision information that ‘acquisition of knowledge and status makes people happy in poor regions’.

The perception of people on specifications of the objects existing objectively refers to an interaction process that an objective world proves a subject world, and the subject world responds to the objective world, thereby realizing capture and application of interaction information, which is the charm of existence of the ET system.

0-1-4: the above described ET system is the reflection of the main functions of the present invention and has the features and the advantages that high-efficiency management for quality evaluation information and quality perception information (collectively called ET information hereinafter, wherein ET means Easy-Traceability) is realized by a quality management theoretical framework and an informatization technology.

0-1-4.1-0: the quality management theoretical framework refers to an spp theoretical framework (spp refers to combination of system, process and production). As shown in FIG. 1, the quality management theoretical framework has the features that the application in the aspect of informatization management is deepened on a basis that relevant technologies, standards and theories of quality management are fully summarized. The spp theoretical framework indicates that the quality management is summarized into three-level comprehensive management (a product level, a process level and a system level), the three-level management is beneficial for making everyone have responsibility for the quality management, putting the quality management into practice and defining the quality management into specific objects, and the theory indicates various management elements, collection sources, communication objects, transmission attributes and present characteristics related to the quality information. From the informatization management perspective, it can be seen that, based on ‘single specification acquisition’ and ‘sample sufficient regulation’, the quality evaluation or perception information of the product level, the process level and the system level from a client, time domain traceability and storage are carried out by the informatization technology, and a mass, data informatization quality management mode is constructed, so as to achieve the purposes of dynamic management for quality perceptions and real-time monitoring and early-warning for the quality information. (herein, the theoretical definitions are made as follows: quality evaluation is a quality perception substantially and has a quality perception with a specific judgment standard; and the quality perception is defined as a trigger effect in a nature and can be summarized into a language or a group of physical, chemical or biological parameters, such as sound, light, electricity, heat, magnetism, radiation, mechanics, dimension, speed and the like, and the parameters can be digitized generally. The further theoretical definitions related to the quality perception information and the three-level quality management. can refer to ‘Research On Construction of Traceability-Based Quality Supervision and Management Information Platform’, College of Economic and Management of Fuzhou University, Master's Thesis, Cao Shukui, issued in 2014, hereinafter referred to as ‘Thesis’.)

0-1-4.2-2.1-3.1-0: description of introduction: the data space model refers to an ET five-dataspace model (hereinafter referred to as an ET model or a five-dataspace model or a model; particularly, also called an ET five-dataspace conceptual model or an ET five-dataspace logical model or an ET five-dataspace physical model when the data space model is endowed some definition or application occasion.). The ET five-dataspace model is shown in FIG. 2, and analytical diagrams of all domains of the ET five-dataspace model are shown in FIGS. 3-7.

0-1-4.2-2.1-3.2-0: description of the application: the data space model refers to a data storage structure, and the data storage structure can be applied in the following two aspects by computer software and hardware technologies:

(1) a database application program maps a vector line (axis), a dot matrix and a color with a specific logic structure in a data model space (or called an X-Y-Z space), so as to form application level information; and

(2) the database application program combines a hardware level compile program to summarize acquisition level information into data 0 and 1 (or computer-identifiable operational data) and a sequence of operation instructions according to a model parameter rule or a function rule, so as to solidify the acquisition level information in a physical address of a semiconductor storage medium (or other memory materials), and the process data/instruction and the formed data information are collectively called storage level, information.

The further discussion about the technical characteristics of the ET five-dataspace model can refer to the ‘Thesis’.

0-1-4.2-2.1-3.3-3: description of the detailed description: the data >storage structure represented by the data space model refers has the external characteristic of having a data dot matrix and a vector graphic conforming to a certain mathematical logic rule and has the internal characteristic of being a data model integrating a conceptual model, a logical model and a physical model.

0-1-4.2-2.1-3.3-3.1-0: the conceptual model refers to that the appearance structure and the logical principle of the model are applied to operation and utilization for the application level information based on a time domain traceability principle of stored information of the ET five-dataspace model, including the situations as follows:

(1) acquisition level ET information is multi-dimensionally classified and mapped at dot matrix positions corresponding to time and geographical positions of objects (i.e., a commodity) in a circulation link, dot matrix positions corresponding to time and geographical positions of the evaluation main bodies, dot matrix positions corresponding to time and geographical positions of objects (i.e., products) in a manufacturing phase, dot matrix positions corresponding to time and geographical positions of processes of the objects and dot matrix positions corresponding to time and geographical positions of general system levels of the objects, and five data space domains are formed by dot matrix piling and linear integral;

(2) data acquisition is carried out on the quality evaluation/perception information in a large number samples based on the spp theoretical framework, the ‘single specification acquisition’ and the ‘sample sufficient regulation’, and the data are structured and mapped in the data model space, so as to obtain a virtual dot matrix structure and realize a tool value of the conceptual model for information spreading;

(3) the quality perception information is collected by an ETAPP (ET Application program), a private channel (such as an RFID (Radio Frequency Identification Device) technology), an intelligent wireless communication detection sensor (such as a wearable device) and the like, the conversion of the information and the data is completed by applying the model of the PgA@, so as to realize information collection/acquisition, and the model of the PgA@ is shown in FIG. 8; and

(4) elements of the specifications are identified by applying the PgA@ (as shown in FIG. 9); graphical recognition and identification is carried out on the quality information by applying the PgA@ (as shown in FIG. 10), the evaluation/perception information is acquired traceably by applying the Ea (as shown in FIG. 11): and the evaluation/perception information is displayed, spread and utilized by applying a graphic (an ET lotus diagram, as shown in FIG. 12) formed by the PgA@, the Ea and the ET model.

The ET five-dataspace conceptual model is mainly applied to collection level ET information, the acquisition level ET information and output level ET information, and the specifications and the dimensions of the ET five-dataspace conceptual model are shown in FIG. 13;

The collection level ET information is mainly realized in a form of ET pointing, and a schematic diagram of an ET pointing interface is shown in FIG. 14; the acquisition level ET information is mainly realized by the model of the PgA@, and the model of the PgA@ is shown in FIG. 8; and

the output level ET information is mainly realized in a form of an ET five-dataspace evaluation display model (i.e., an ET lotus diagram, as shown in FIG. 12).

Particularly, the ET five-dataspace model can be endowed with a group of response features as follows by a program when the ET information is operated and applied:

screen up/down: which refers to that the dimension of the ET conceptual model is changed in proportion, so as to adapt to receiving, watching and propagation of conveyed information of target viewers under different environments and different hardware environments (such as resolution ratio) and from different visions; and

read.#.cone: which refers to that an instruction is sent by client software (such as the ETAPP) (such as clicking a corresponding button or pattern on a screen), the ET conceptual model pushes corresponding content information to the target viewers (a B/S (Brower/Server) system architecture) dimensionally and graphically, or pushes necessary data to the ETAPP (a C/S (Client/Server) system architecture), and the read.#.cone instruction triggers the ET system to search, calculate and analyze storage analysis level ET information and push the output level ET information to the client.

The client has a certain regulation requirement on an expression manner of quality perception when the ET conceptual model is applied (in particular to an ETAPP collection/acquisition form), and an ET information collection and expression rule appointed by the ET system is shown in FIGS. 15-16 and is mainly used for completing conversion of information of the ET pointing interface (the collection/acquisition level ET information) and the data of the model of the PgA@ (the acquisition level ET information and the storage analysis level ET information).

Particularly, it should be noted that, the ET conceptual model and the ET logical model are inseparable, which is just like the value of a material, the application and the using principle (the ET conceptual model) of the material are determined by the property (the ET logical model) of the material, and the property of the material is determined by the inner structure (the ET physical model) of the material. The ET conceptual model and the ET logical model are the basis of graphical processing of the ET information, the processing for the graphical data of the ET model by the ET system can be seen in FIG. 17 (ET evaluation dimension graphical display logic), as shown in FIG. 17, part a is evaluation of production dataspace (8 dimensions), which includes: 1. overall perception evaluation, 2. product ‘component’ and ‘material’ evaluation, 3. appearance evaluation, 4. color evaluation, 5. evaluation on some performance of product, 6. evaluation on product size, 7. evaluation on product reliability, 8. evaluation on product safety and compliance; part b is evaluation of system dataspace (14 dimensions), which includes: 1. industrial competitiveness (exogenous competitiveness), 2. value chain (exogenous competitiveness), 3. customer satisfaction (exogenous competitiveness), 4. michael Porter's five forces model (exogenous competitiveness), 5. internal and external environments (endogenous competitiveness), 6. knowledge (endogenous competitiveness), 7. financial condition (endogenous resource competitiveness), 8. human resource (endogenous resource competitiveness), 9. marketing (endogenous resource competitiveness), 10. enterprise culture, technology and materials strategy (endogenous resource competitiveness), 11. executive capability (endogenous competitiveness), 12. innovation ability and leadership, 13. inheritance result, 14. overall impression evaluation; part c is Evaluation of product/service formation process (6 dimensions), which includes: 1. human, 2. machine, equipment and facility, 3. material, 4. method and skill, 5. environment provided b production or service, 6. management and control for measurement and monitoring; part d is evaluation of goods dataspace (8 dimensions), which includes: Overall perception evaluation, 2. product ‘component’ and ‘material’ evaluation, 3. appearance evaluation, 4. color evaluation, 5. evaluation on some performance of product, 6. evaluation on product size: 7, evaluation on product reliability, 8. evaluation on product safety and compliance. FIG. 18-20 are an analysis on a measurement logic rule of the acquisition of the graphical data, FIGS. 21-22 are a mathematical function rule of graphical mapping reduction, and FIGS. 23-24 show a computer search rule (a vector axis, a posture and three-dimensional coordinate parameter rule) of structural data in a data space.

The definitions related to the application of the ET five-dataspace conceptual model are described as follows:

Ih: Ih is a symbol of an infliction host and is a point (the point is a bit of a dot matrix of a computer, the position is determined by a three-dimensional coordinate system, and the color and the shape are defined by an ET information system) defined in the five-dataspace model; when some objective object (people, matters and things) have active or passive interaction with men and generates perception of the men on the object, the perception is triggered at some time, at some geography and under some environment, one Ih of a triggering point in the ET model is defined, and the further definition and description of the Ih can be seen in the definition in the above ‘ET quality perception process’ (the case A).

Rh: Rh is a symbol of a receive host and is some point in an ET five-dataspace model system, and the point determines an evaluation object as well as the geographical position and the time of the evaluation object.

Ea: Ea is a symbol of an evaluate axis, a directional vector line segment arrow with three-dimensional parameters is constructed in order to facilitate acquisition, analysis and evacuation of a computer graphic identification system for useful information in traceability quality information in a five-dataspace dot matrix model system, and the direction starts from the Ih and ends at the Rh.

Five-dataspace pointing: five-dataspace pointing is also called ET pointing; FIG. 14 is the ET pointing interface; and the ET pointing refers to a process of establishing the PgA@ in the five-dataspace model space when the men trigger the Ih. The output of the ET pointing is recorded in a graphic database of the ET five-dataspace model and comprises pointing for seven parameters: pointing for a quality host, pointing for the PgA@, pointing for a goods dataspace, pointing for a men dataspace, pointing for a production dataspace, pointing for a process dataspace and a pointing for a system dataspace. Generally, the system suggests that the ET pointing needs follow the ‘sample sufficient regulation’, and the ET pointing interface usually appears in the ETPP.

PgA@: PgA@ is a symbol of a perception gene axis, refers to a tendency axis and is defined as one of various specifications parasitic in the quality host, and the specification usually causes the damage to some right and interest of the men and is the root cause the men initiate the gene axis; the PgA@ represents the development tendency of the core functions and the specifications of a product with similar function utility and strong market substitutability, is a core line of the ET five-dataspace model and is the core reflection of the technical features of data acquisition of the ET five-dataspace model (‘single specification acquisition’), the PgA@ usually selects and follows the ‘sample sufficient regulation’, and the PgA@ derives a PgA@ plane.

PgA: the ET system affirms that PgA is the earliest triggered model of the PgA@, the symbol of the axis does not have @, the five-dataspace model of the PgA is called the model of the PgA, and a CMCP (Core Model Coordinate Point) is the original point of a three-dimensional coordinate with an X axis, a Y axis and a Z axis.

Information host: an information host is also called a quality host (Qh) and refers to an object having some specification, expected similar functions and application and some quality information; the Ih is usually parasitic in some Qh; the evaluation object has uncertain quality of men/using main bodies, and the Rh, depends on quality perceptions of different men at different times, at different geographies and under different environments, therefore, the Qh comprises numerous Rias. The definition of the Qh is commonly formed by a sample host, an individual host and a specification element host, and FIG. 10 (the PgA@ plane) paraphrases the logic structure of the Qh. A mapping graph of the sample host consists of a system-specification dataspace and an identification code endowed by the system-specification dataspace and reflects design and setting parameters of a product of a manufacturer, and the individual host is a sequence product manufactured according to the design and setting parameters and reflects the design and setting parameters, requirement parameters of consumers and time domain parameters of the system dataspace, and a mapping graph of the individual host consists of a system-application dataspace and an identification code endowed by the system-application dataspace.

Time axis system: a time axis system is an axis for recording triggering time of the Ea and is usually applied when a database establishes a cache model (in order to reflect the distribution status of evaluations of the PgA@ objectively in real time, the ET system establishes the cache model for the PgA@, and the cache model may be realized in a form of distributed data management or in a cloud storage manner), all or part of the time axis system are feed back to the consumers, and the time axis system is also used for perception dimension analysis and an ET scanning analysis.

Geography axis system: a geography axis system is an axis for recording the geographical position of the Ea and is usually applied when a database establishes a cache model (in order to reflect the distribution status of evaluations of the PgA@ objectively in real time, the ET system establishes the cache model for the PgA@, and the cache model may be realized in a form of distributed data management or in a cloud storage manner), all or part of the geography axis system are feed hack to the consumers, and the time axis system is also used for perception dimension analysis and an ET scanning analysis.

ETAPP: an ETAPP is an information management application program of an ET client.

Sample Sufficient Regulation: for a probability theory of mathematics and a statistic analysis of data, sample sufficient regulation is the basis of all information statistic analyses and refers to traceability management for quality information, the purpose of the sample sufficient regulation is not only limited to decisive help of the information to investigation to past situations, the sample sufficient regulation aims at how to ensure objectivity, fairness, science and accuracy of the information to a greater extent, and the sample sufficient regulation has representativeness and predictability and is the reflection of the concept of ‘quality management prevention is prior to control’ of the ET system.

Single Specification Acquisition: single specification acquisition refers to that one of various quality factors of an object are measured, recorded, analyzed and informationally stored in a multi-dimension and high accuracy manner.

0-1-4.2-2.1-3.3-3.2-0: the logical model refers to that: a dot matrix structure of the ET five-dataspace model follows a specific logic law/parameter configuration, the logic law/parameter configuration usually appears as a group of operational characters for operation for reduction data in a database application program, and the group of operational characters can be converted into binary data 0 and 1 or a data system capable of being identified and calculated by a computer by a compiling program and the logic law also refers to that three-dimensional space coordinates (or X-Y-Z spaces) are established in a computer database and are classified and stored into a goods dataspace (code: space.1), a men dataspace (code: space.2), a production dataspace (code: space.3), a process dataspace (code: space.4) and a system dataspace (code: space.5), and evaluation/perception information is classified in a five-dimension manner.

All parameters of the ET five-dataspace logical model are paraphrased as follows:

1. Goods dataspace: a feature identification diagram of a goods dataspace is shown in FIG. 3; a using method of the goods dataspace comprises: acquiring/storing/recording goods Rhs of a circulation link, wherein the good Rh particularly refers to an Rh of a quality perception object in a period of time after a seller and a buyer have a transaction behavior in the service industry; the composition principle is that: a dot matrix structure of the overall goods dataspace refers to integrals of a dot matrix plane of the good Rh, shows a time-domain traceability chart of goods in the direction of a gene axis with a time axis t(good) and is expressed as 0+∞∫[lnΣ(xNS,yWE)(t(good′)](t(good)).

2. Men dataspace: a feature identification diagram of a men dataspace is shown in FIG. 4; a using a method the men dataspace comprises: acquiring/storing/recording time domains and Ihs of men; particularly, permissions can be designated for selection of the men dataspace. For example, for evaluations on the system dataspace, more permissions are opened to a third-party evaluation institution or an individual or organization with strong three-level quality perception due to the professionalism and the objectivity of the evaluations; and the composition principle is that: the overall men dataspace refers to integrals of a dot matrix plane of Rhs of men, shows a time-domain traceability chart of men with a time axis t(men) and is expressed as: 0+∞∫[lnΣ(xNS,yWE)(t(men′)]t(men)).

3. Production dataspace: a feature identification diagram of a men data pace is shown in FIG. 5: a using method of the production dataspace comprises: acquiring/storing/recording a production Rh, wherein finished products comprise tangible products of the manufacturing industry and service processes of the service industry, and particularly, the production Rh refers to a quality perception object in a period of time before a seller and a buyer have a transaction behavior; and the composition principle is that: the overall production dataspace shows integrals of a dot matrix plane of production Rhs and is expressed as: 0+∞∫[lnΣ(xNS,yWE)(t(product′)](t(product)).

4. Process dataspace: a feature identification diagram of a process dataspace is shown in FIG. 6; a using method of the process dataspace comprises: acquiring/storing/recording an Rh of a process that product value is formed, and particularly, the ET system endows a specific identification code to the process dataspace in consideration of influence factors of the process for the PgA@ particularly having the representativeness of the Qh; and the composition principle is that: the overall process dataspace shows integrals of Rhs of the process that the product value is formed and is expressed as: 0+∞∫[lnΣ(xNS,yWE)(t(pr′)](t(pr)).

5. System dataspace: a feature identification diagram of a system dataspace is shown in FIG. 7; and the system dataspace consists of a specification dataspace, an application dataspace and a posture. A system dataspace plane consists of a specification dataspace plane, an application dataspace plane, a horizontal posture and a three-dimensional posture, visualization parameters of the specification dataspace plane define a sample attribute of the Qh, and visualization parameters of the application dataspace plane define an individual attribute and an Rh of the Qh. A using method of the system dataspace comprises: acquiring/storing/recording attributes, the Rh and an Ih of the Qh, and a Qh plane derives the PgA@ plane and an axis direction; and the composition principle is that: the overall system dataspace shows integrals of the Rh and the Ih of the Qh and is expressed as: 0+∞∫[lnΣ(xNS,yWE)(t(s′)](t(system).

5-1: System-specification dataspace: a feature identification diagram of a system-specification dataspace is shown in FIG. 7; and a using method of the system-specification dataspace comprises: acquiring/storing/recording product function requirements, design indexes and Rhs according to more considerations from the aspect of the consumers (value users).

5-2: System-application dataspace: a feature identification diagram of a system-application dataspace is shown in FIG. 7; and a using method of the system-application dataspace comprises: acquiring/storing/recording product function requirements, application demands and Rhs according to more considerations front the aspect of the consumers (value users).

Tg′A: a time (goods dataspace) differentiation axis, used for checking information quality of an Rh of the goods dataspace and searching time element information;

Tm′A: a time (men dataspace) differentiation axis, used for checking information quality of an Ih of the men dataspace and searching time element information;

Tp′A: a time (production dataspace) differentiation axis, used for checking information quality of an Rh of the product dataspace and searching time element information;

Tpr′A: a time (process dataspace) differentiation axis, used for checking information quality of an Rh of the process dataspace and searching time element information, wherein the process refers to a group of activities that input is converted into output, which is defined in the quality management field;

Ts′A: a time (system dataspace) differentiation axis, used for checking information quality of an Rh of the system dataspace and searching time element information, wherein the system refers to a concept summarized in the quality management field: a set of the process, the set comprises a group of management methods, and the management methods are established on a certain resource basis; and generally, the system refers to a right main body or a control main body of the set of the process and usually refers to an enterprise entity;

TgA: a time (goods dataspace) axis, used for periodically tracing an Rh of the goods dataspace and searching time element information;

TmA: a time (men dataspace) axis, used for periodically tracing an Rh of the men dataspace and searching time element information;

TpA: a time (production dataspace) axis, used for periodically tracing an Rh of the production dataspace and searching time element information;

TprA: a time (process dataspace) axis, used for periodically tracing an Rh of the process dataspace and searching time element information;

TsA: a time (system dataspace) axis, used for periodically tracing an Rh of the system dataspace and searching time element information;

WE1: a longitude coordinate of goods, used for checking information quality of an Rh of the goods dataspace and searching position element information;

NS1: a latitude coordinate of goods, used for checking information quality of an Rh of the goods dataspace, and searching position element information;

WE2: a longitude coordinate of men, used for checking information quality of an Rh of the men dataspace and searching position element information;

NS2: a latitude coordinate of men, used for checking information quality the men dataspace and searching position element information;

WE3: a longitude coordinate of production, used for checking information quality of an Rh of the production dataspace and searching position element information;

NS3: a latitude coordinate of production, used for checking information quality of an Rh of the production dataspace and searching position element information;

WE4: a longitude coordinate of a process, used for checking information quality of an Rh of the process dataspace and searching position element information;

NS4: a latitude coordinate of a process, used for checking information quality of an Rh of the process dataspace and searching position element information;

WE5: a longitude coordinate of a system, used for checking information quality of an Rh of the system dataspace and searching position element information;

NS5: a latitude coordinate of a system, used for checking information quality of an Rh of the system. dataspace and searching position element information.

0-1-4.2-2.1-3.3-3.3-0: the physical model refers to a design of a physical address etching solution and an interface compiled language for a storage medium (a semiconductor or other memory materials) in order to accelerating searching calculation and parallel calculation of the computer for the data according to the distribution features of the structural dot matrix stored by the data of the ET five-dataspace model and the logic law/parameter configuration in combination with a hardware level storage calculation technology.

0-1-4.2-2.2-2: a group of data processing and analyzing methods refers to a group of structural data storage rules and a group of graphical data processing and analyzing methods.

0-1-4.2-2.2-1-2: the group of structural data storage rules refers to an ET model posture and an ET model set array rule;

0-1-4.2-2.2-2.1-2.1-4: the ET model posture refers to an inclination angle posture, a horizontal posture and a vertical posture of the PgA@ plane endowed by the ET model by the database application program in the data space (the X-Y-Z space).

0-1-4.2-2.2-2.1-2.1-4.1-0: the PgA@ plane consists of the PgA@ (the PgA), the system-application dataspace plane, an individual host identification code, a system-specification dataspace plane, a sample host identification code, a process dataspace plane, a process dataspace identification code, a production dataspace plane, a goods dataspace plane, a men dataspace plane, the inclination angle posture, the horizontal posture and the vertical posture.

Herein, the PgA@ is indicated in the following two aspects:

Indication 1: even if the probability that the number of the information host is greater than 1 at the same geographical position and at the same moment is very small, the probability is possible, and the PgA@ plane defines the uniqueness of the information host based on the above parameters.

Indication 2: for the problem that the axial horizontal posture and all the identification codes are overlapped logically, on one hand, in view of the supply and demand aspect of quality management, the axial horizontal posture and the identification codes are a group of complementary parameters, and from the aspect of a supplier, the fluctuation of the process (or the capability of a manufacturing process) possibly causes the difference the change of the axial horizontal posture) of the individual host (the production dataspace) and even the qualitative change of the specifications (the change of the axial inclination angle posture); and from the aspect of a demander, the horizontal posture defines a response appearing after the product is delivered to the consumer and obtains perception, and the process dataspace identification code refers to identification made only based on the product design of the supplier (or the understanding of the supplier to the demander, wherein the understanding does not represent the perception of the demander to the final product. The further discussion about perception can be seen in section 2.1.4 of the ‘Thesis’); and the above definition manners can effectively avoid unreasonable evaluations of the men to the process dataspace (the evaluations of the men on the process often generate a subjective, unprofessional or distorted situation.), which plays an important role in the checking and analysis of the ET information.

On the other hand, in view of information analysis and early-warning for the information host having the quality safety problems (such as food and food additives), the PgA@ of expected products and composition specification status of the existing products are a pair of emerging tendencies, therefore, it is inevitable that tracing, identification and analysis are carried out from the two sources of cause and result of the quality evaluation, the dot matrix of the system dataspace (the Rh) is used for recording the evaluation of the consumer on ‘result’, and a preset identification code is used for tracing the reason causing ‘bad result’.

The above sample host identification code refers to a graphical feature of the system-specification dataspace endowed by the system by default or by operation, and a dot matrix code and an axial inclination angle posture included in the sample host identification code codetermine a sample host;

0-1-4.2-2.2-2.1-2.1-4.2-0: the above inclination angle posture of the PgA@ plane refers to that the PgA@ plane rotates a certain angle around the PgA@ (defined as autorotation of the ET five-dataspace model), is used for identifying some specification parasitic in the Qh by the computer and is expressed as: RECT.spec, the range of the inclination angle posture is: RECT.spec∈[0,360], the format of definition language is: VALUE.RECT.spec=[1,n](n∈+∞), and the mapping is: 1-n specifications of some sample host;

For the angles of characteristic elements in the process of data operation, the changing speed of angle parameters in an arithmetic device is called a model axial chattering coefficient ETQF (ET Quality perception Frequency, or ET perception dispersity, or ET thinking dispersity).

0-1-4.2-2.2-2.1-2.1-4.3-0: the above horizontal posture of the PgA@ plane refers to a posture with some angle formed in a way that the PgA@ plane rotates around an Z axis on an X-Y plane by taking a right-angle endpoint (point.CMCP) of the system-application dataspace as a base point and is defined as an individual track of the ET five-dataspace model by the system, the mapping language is expressed as: PgA.n.tracking, the horizontal posture is used for identifying a geographical position track of some individual host (one of derivative individuals of the sample host)by the computer and is expressed as: RECT.PgA.n, the numerical range is: RECT.PgA.n∈[0,360], the mapping range is: VALUE.RECT.PgA.n=[1,n](n∈+∞), and the physical meaning of the mapping is: n products derived by some sample host;

The above some angle refers to included angles α, β and γ formed by PgAs A, B and C and the original point of an X-Y-X plane, and the differences between the included angles α, β and γ and included angles ∠1, ∠2 and ∠3 formed by some original sites a, b and c (different regions have different original sites when the original sites are applied to ET data management of different regions, and technically, some global solution of an unique site can also be adopted.) and the original point of an X-Y-X plane are defined as cluster traceability angles Δα, Δβ and Δγ.

In some cluster model of the PgA, the change frequencies of the cluster traceability angles (such as Δα, Δβ and Δγ) generated in the graphical data processing process are reflected in the application level information and is called a model horizontal chattering coefficient ETW (ET Wave, or perception wave or coefficient) when a digital operation device (a computer) carries out cluster/integrated storage on a derived model.

0-1-4.2-2.2-2.1-2.1-4.4-0: the above vertical posture of the PgA@ plane refers to an axial deviation angle from the PgA@ of the ET five-dataspace model to the PgA plane (generally, the direction of the Z axis is selected, Z values under different processors are shown when in different cluster/integrated storage operation forms, and it can be understood as a TsA axis usually) in the axial direction, which is called a vertical posture angle of the model (defined as vertical autorotation of the ET live-dataspace model, i.e., the vertical posture). The vertical posture is expressed as: RECT.MODEL.Z, the numerical range is: RECT.MODEL.Z∈[−90,90], the mapping range is: VALUE.RECT. MODEL.Z=critical value of product quality characteristic (the changing range of the quality characteristic is equal to the range of sample strength under a standard condition and is paraphrased as some quality characteristic of some product, and the supply and demand strength is equal and balanced.), for example, the range of normal body temperature is 36.5°°C.-37.5° C., it is apparent that data are suspicious when the acquired data is 15° C. or 65° C., it is possibly that the quality characteristic are changed into ‘freezing body temperature’ or ‘baking body temperature’, which is not the expected range of the sample strength.

The model vertical posture angle is also called a per.dem dip angle ETPP (ET Perception Pressure) when in application in the application level data information, and for the per.dem dip angle ETPP in the data operation process, the changing speed of angle parameters in an arithmetic device is called a vertical chattering coefficient ETP (ET Pressure, or ET supply-and-demand perception variation coefficient).

0-1-4.2-2.2-2.1-2.2-0: the above ET model set array rule refers to:

a systematic data storage solution made for combining response of data acquisition, structural storage and classified searching of the data, storage capacity and the like when the ET system storages the data for the model of the PgA and a model of a derivative PgA@. The relevant definitions are described as follows:

(1) T&G dataspace: a T&G dataspace is a dot matrix structure in a three-dimensional coordinate system defined in a computer information base, wherein each of the points corresponding to a specific geographical position at some moment, and the T&G dataspace is usually defined by an X axis, a Y axis and a Z axis.

ET model space: an ET model space is a three-dimensional data space defined by the database application program. Due to one possibility that the mode of the PgA is generated at the same time and at the same geographical position, at this time, the database application program establishes a data storage space for a conflict model (or data redundancy) to classify and isolate data of the conflict model, the system defines the data storage space as an ET model space, and any space of the model of the PgA established earliest at some geographical position belongs to one of the three-dimensional data spaces. A space overlapping calculation operation (overlapping of the ET model spaces) is executed on all ET model spaces through time-geography interactive mapping, and a simplest example that the operation meaning of overlapping of the ET spaces is described as follows: the system laterally searches time domains in the database to discover all Rhs or His generated at some time point or at some geographical position and the contents thereof.

The T&G dataspace is usually defined by the X axis, the Y axis and the Z axis, wherein

X: exists in a computer data space, is one of the three-dimensional coordinate and is usually used for data storage pointing;

Y: exists in a computer data space, is one of the three-dimensional coordinate and is usually used for data. storage pointing;

Z: exists in a computer data space, is one of the three-dimensional coordinate and is usually used for data storage pointing;

(2) Basic coordinate axis system: a basic coordinate axis system refers to the above X axis, Y axis and Z axis which are a group of important factors used for the computer to apply mathematical logics to search relevant elements, play double roles of a time domain physical space and a storage physical space in the data space and serve an internal logic space and an external color space, and the application of the basic coordinate axis system can refer to the application of an ET early-warning element function curve;

(3) Cause and Result ET Axis: a cause and result relationship (or a supply and demand relationship) exists between the system-specification dataspace and system-application dataspace; since the problem of cross model connection exists in the acquisition process of traceability information, the cause and result ET axis is defined to solve the problem of a tracing mainline of the cause and result relationship; the cause and result ET axis starts from a system-specification dataspace in a cause model and terminates at a system-application dataspace in a result model; a system-specification dataspace of the model of the PgA also has a directed axis pointing to the system-application dataspace (the directed axis is designated by the system), and the directed axis is used for the ET system to establish a relationship between the model of the PgA and a newborn model (as shown in FIGS. 25-27);

(4) Assistant ET Axis: an assistant ET axis is an axis which starts from a system-specification dataspace in the model of the PgA@ (a response is made for a men dataspace of the PgA before initiation) and terminates at the system-application dataspace in the model of the PgA and is used for the ET system to establish a relationship between the model of the PgA and an assistant cause and result model (a model related to the benefit of the PgA and having an expected cause and result relationship with the model of the PgA) (as shown in FIGS. 25-27);

(5) Partner ET Axis: a partner ET axis is an axis which starts from a system-application dataspace and terminates at the system-application dataspace in the model of the PgA, the system-application dataspace of the model of the PgA also has a directed axis pointing to the system-application dataspace (the directed axis is designated by the system), and the partner ET axis is used for the ET system to trace a model set with an original perception attribute (as shown in FIGS. 25-27);

(6) Partner Gene ET Axis: a partner gene ET axis is an axis of a computer data model that a system-application dataspace in a five-dataspace model points a system-application dataspace in the model of the PgA, wherein the five-dataspace model similar to the model of the PgA is established by the men when the quality perception similar to the PgA is initiated, and the partner gene ET axis is used for establishing a relationship between the models in a model domain (as shown in FIGS. 25-27);

(7) Space Linking ET Axis: a space linking ET axis is an axis for connecting equal dataspaces (such as a goods dataspace-a goods dataspace, a production dataspace-a production dataspace . . . ) between the models. The space linking ET axis is used for the ET system to establish a relationship between five domains of the models and five domains of other models, and the relationship can assist the assistant ET axis to objectively check the cause and result relationship; the space linking ET axis aims at facilitating the ET system to quickly establish an organic relationship among all model domains, is usually defined when information is acquired, depends on ET pointing information contents of the men and is intelligently judged by the computer. For example, the assistant ET axis of the system dataspace is an axis which starts the system-application dataspace and terminates at the system-application dataspace and is used for cooperative tracing for lhs initiating a same gene axial direction (as shown in FIGS. 25-27);

(8) Cross space Axis: the ET system sets a cross space axis for searching and analyzing for a cluster dot matrix data structure, for example:

a time-geography interactive mapping refers to a group of instructions defined in the database application program, is used for pointing among all three-dimensional data spaces in the establishment process of a database space and is used for starching and tracing between the spaces, and the time-geography interactive mapping is used for identifying and isolating a plurality of PgAs initiated at the same geographical position and at the same time point.

0-1-4.2-2.2-2.23: the group of graphical data processing and analyzing methods refers to an ET early-warning element function curve analysis, ET mining and ET scanning.

0-1-4.2-2.2-2.2-3.1-0: the ET early-warning element function curve analysis refers to that:

the computer is used for graphical identification for evaluation/perception information data in the ET five-dataspace model, so as to obtain a quantized value of the data of the dot matrix structure and carry out physical change of the quantized value, for example, each dot matrix is converted into a physical force value, models are endowed to the dot matrixes to corresponding to physical mechanical states (such as floating upward and sinking), the ET early-warning element function curve draws the physical mechanical states reflected by the models into a mathematical curve and carries out a correlation analysis.

Related concepts analyzed by the ET early-warning element function curve are defined as follows:

1. Per.dem: per.dem is defined as a product of per.vol and per.par;

(1) Calculation Method of per.vol:

per.vol comprises: per.tot and per.pow., wherein per.pow comprises per.abi (triggering degree), per.fre (time frequency) and per.dens (geography dispersion);

per.vol=per.tot*per.pow, i.e., Ea tot*per.abi*index.per.fre*index.per dens;

per.abi usually refers to a group of coefficients and generally selects some value from ⅓, ½, 1, 2, 3, 4 and 5, and the selection of the value is given by an evaluation/perception credit rating (the index is appointed by the ET system) of the men.

(2) Calculation method of per.par:

per.par is obtained by calculating all dimension values of the Ea. According to a conversion rule of value quantization of all dimensional Eas of all dataspaces and per.par, the ET system appoints the following:

evaluation Ea: red, orange, yellow, green, blue, indigo and purple respectively correspond to 7, 6, 5, 4, 3, 2 and 1; and

perception Ea: a front surface (3), a back surface (−3) and no output (1)

It is particularly indicated that,

the response features of the computer database are described as follows when the collection level ET information (ET pointing) and the acquisition level ET information (when the model of the PgA@ and the Ea are generated) are converted:

an application level ET information response feature:

a graphical process of dimensionally mapping the perception information into the ET five-dataspace conceptual model is shown as FIG. 17 and FIG. 12; and

particularly, for a measuring value, such as body temperature (it is assumed that the standard fluctuation range is 36.0° C.-37.9°° C.), the ET system appoints that: graphical mapping is realized according to the rules in FIGS. 18-20 under rules of an effective perception range (given by appointing of the ET system) and a standard perception scale (given by appointing of the ET system), a mathematical ride of a dimensional process is shown in FIG. 21, and a database execution and processing logic is shown in FIG. 22;

a storage level ET information response feature:

a corresponding stack buffer path is searched in the database for the acquired ET pointing interface—the PgA@, the PgA is found, and an optimal cache model is researched (pointing is carried out on the region according to the acquired geographical position usually, and an affiliation region is selected and cached if the PgA@ is not researched in the region), so as to achieve the purpose of distributed data storage. At the spare time of a database center, the ET system executes data clone for the model of the PgA and a distributed cache model, the data operation between a distributed model space database and a standard model space database (the database center) follows an ET cross model space axis rule (such as an ET cross dataspace passageway).

FIGS. 23-27 are schematic diagrams of storage logic structures of storage level ET information, and relevant specifications can be seen in the ‘ET model set array rule’ (section ‘0-1-4.2-2.2-2.1-2.2-0’). In FIG. 25, a represents the longitude and latitude and the time coordinate values of the point, which, which is used for tracing an information releaser ([Rh]), b represents the pointing of an[Ea], which is used for tracing a relationship of an evaluator and an evaluation object; c represents the longitude and latitude and the time coordinate values of the point, which are used for tracing an evaluation information carrier (goods dataspace [Rh]); d represents the longitude and latitude and the time coordinate values of the point, which are used for tracing an evaluation information carrier (production dataspace [Rh]); e represents the longitude and latitude and the time coordinate values of the point, which are used for tracing an evaluation information carrier (process dataspace [Rh]); f represents the longitude and latitude and the time coordinate values of the point, which are used tier tracing an evaluation information carrier (system dataspace [Rh]); g represents the pointing of a [PgA@], which is used for defining the attribute of evaluation information; h represents a [cause and result ET axis], which is used for tracing two models of a supply and demand relationship; i represents an [assistant ET axis], which is used for tracing a model and a PgA that have a competitive relationship with a supplier; j represents a[partner gene ET axis] and a [perception linking ET axis], which are used for tracing a model and a model of a PgA that have a relationship of rights and interests with a demander (pointing to the perception linking ET axis); k represents a [space linking ET axis], which is used for establishing a tracing relationship between models with a same PgA@. In FIG. 26, a is abnormal sound of car.

Comprehensively, the management of the ET system for the quality perception information is mainly completed around the PgA@ and the Ea, the PgA@ mainly supports coordinate position of the storage level ET information in an ET data model space, fast and parallel searching of mass data and traceability joining, the Ea mainly supports graphical and dimensional data operation for the application level ET information, an overall technical from of the ET system can be seen in FIG. 28, and a logic execution ride of the PgA@ in an operation process of the ET system can be seen in FIG. 29.

Particularly, for the searching based on a regional time domain/other information elements, the ET system realizes searching and classified storage for a geographical position element, a time position element, a PgA@ element and other information elements adopted for the ET model by an ET geography passageway, an ET time passageway and an ET cross dataspace passageway.

The ET geography passageway refers to an advance line defined in the database space when the system executes ET pick up for ET models, the ET pick up is carried out according to a linear curve of some function (a coordinate value of a geography axis is taken as a control element), the ET pick up refers to that the ET models are picked up, classified, stored, sorted and analyzed for some geographical position by the ET scanning or the ET mining;

The ET time passageway refers to an advance line defined in the database space when the system executes ET pick up for the ET models, the ET pick up is carried out according to a linear curve of some function (a coordinate value of a time axis is taken as a control element), the ET pick up refers to that the ET models picked up is classified, stored, sorted and analyzed for some specific time point or some PgA by the ET scanning or the ET mining; and

The ET cross dataspace passageway refers to an ET space searching line established, by taking the time-geography interactive mapping as a parameter in an ET space set array defined by the database application program, The ET cross dataspace passageway is formed based on the following four possibilities:

first, an axial relationship is established artificially, such as the cause and result ET axis, the assistant ET axis, the perception linking ET axis, the partner gene ET axis and the space linking axis (as shown in FIG. 23 and FIG. 25);

second, since it is insufficient for identify the PgA@ (for example, at the same geographical position in the ET five-dataspace model, namely, a WE value is equal to an NS value, but the men are located at different floors or altitudes), or the PgA@ needs to be particularly processed in the X-Y-Z space, segmentation space processing is implemented. This situation is also called an ET gene axis passageway;

third, cluster information of an individual model is interactively mapped to the X-Y-Z space when the early-warning element function curve is formed, this situation is also called an ET gene axis cluster passageway, and details can be seen in the time-geography interactive mapping; and

fourth, due to the demands of system cache and distributed data storage management, an operation with a space database of a model of a derivative gene axis is executed (as shown in FIGS. 26-27).

2. Early-Warning Element:

The ET system processes the quality perception information stored in the ET model space by an early-warning element analysis method, so as to obtain useful decisive information.

Definition of early-warning element: an early-warning element refers to a group of parameters used for expressing the severity degree of the deviation of the specifications from the supply and demand balance and is defined by a difference value between criQ.supply and criQ.dem; and

calculation and issuing of criQ.supply:

the value of criQ.supply is a location standard of an ET five-dataspace model set space on the Z axis, the calculation for the criQ.supply is codetermined by the per.dem of a model set formed by the PgA, the cause and result ET axis, the assistant ET axis, the perception linking ET axis, the partner gene ET axis and the space linking ET axis, and the value is usually considered finally in an overall planning manner and issued statistically by periodical data analysis for criQ.dem and periodical macroscopic searching and sorting for the base standard of the specifications of the ET system.

Calculation Method of criQ.dem:

criQ.dem comprises criQdem.use, criQ.dem.pr, criQ.dem.p, criQ.dem.g and criQ.dem.m (it is particularly indicated that in the calculation method given herein, only the situation of the evaluations/perceptions of the consumers is considered, and the evaluations/perceptions of a third party and the government are not added). A calculation formula is described as follows:

g(per.dem)

=MODEL(per dem)+1+∞ΣMODEL@(per dem)

=[0t∫cri.Q.dem.use d(t)+0t˜criQ.dem.pr d(t)+0t∫criQ.dem.p d(t)+0t∫criQ.dem.g d(t)+0t˜criQ.dem.m d(t)]+0+∞Σ[0t∫ctiQ.dem.use@d(t)+0t∫criQ.dem.pr@d(t)+0t∫criQ.dem.p@d(t)+0t∫criQ.dem.g@d(t)+0t∫criQ.dem.m@d(t)]

Herein, it is assumed that the sum of cross space model components derived by the PgA is +∞, and the model components refer to the cause and result ET axis, the assistant ET axis, the perception linking ET axis, the partner gene ET axis and the space linking ET axis derived by the PgA.

Particularly, the calculation formula of the PgA is described as follows: g(per.dem)=[0t∫criQ.dem.use d(t)+0t∫criQ.dem.pr d(t)+0t∫critQ.dem.p d(t)+0t∫criQ.dem.g d(t)+0t∫criQ.dem.m d(t)].

3. ET Function Curve:

A five-dataspace model set array space of a PgA@-body temperature is taken as an example (as shown in FIG. 30). It is particularly indicated that: the per.dem of the five-dataspace model appearing under an array plane of the PgA is relatively bigger, which indicates that the perceptions on the body temperature of the men have an early-warning triggering point. It is also discovered that, a derived model of the PgA can find location of a Z axis @ and location of an X-Y plane @ again with the triggering of a newest Ea with the movement of the men on the X-Y geography plane @.

For a space of the derived model (@ is usually added as the difference from a space of the model of the PgA):

the location of the Z axis @: the location is determined by the ET system according to criQ.dem, and the original criQ.dem (a parameter of the Z axis) is equal to sample strength.

The location of the X-Y plane @: the location is interactively mapped to a geography point with densest men in an optimal decision of the ET system. The system detects the geographical position of densest Ihs at first and then interactively maps the geographical position to the corresponding geographical position on the X-Y plane @.

Therefore, the system obtains a curve which starts from the PgA (point.CMCP) and connects models of derivative gene axes of triggering time products of all Eas in series.

A trendline (g(human temperature)d(Z)|X,Y=const) of the Z axis @ of the curve indicates the fluctuation situation of the body temperature in the Ihs (i.e., the difference situation of the mean value of the body temperature of residents in the region and an expected standard value);

a trendline g(human temperature)d(X,Y)|Z=const) of the X-Y plane @ of the curve indicates the fluctuation situation of region frequencies of the body temperature in the Ihs (i.e., some region with the most positive uploading situations of body temperature information of the residents in the region); and

a density tendency chart g(human temperature)|(X,Y),Z=const) of the derivative gene axes connected with one another in series by the curve indicates the fluctuation situation of time frequencies of the body temperature in the Ihs (i.e., the fluctuation situation of interval time of two times of acquisition or interval time reaching an early-warning value).

It is assumed that the ET system monitors an ET information base of a PgA@-environmental noise at the same time, therefore, the above ET early-warning element function curve is also formed, and three trendlines/trend charts are generated.

The correlation of the trendlines of the PgA@-environmental noise and the PgA@-body temperature is analyzed, which has great value for early warning of quality perception and problem tracing.

0-1-4.2-2.2-2.2-3.2-0: ET Mining:

ET mining refers to a step of the ET pick up of the ET models, and the system endows a specific per.dem (mining strength) to ET models identified by the ET scanning, so that the models sinks to the bottom of the X-Y-Z space, so as to be prepared for classifying and sorting of the ET models and the model set.

The ET mining refers to a group of processes of copying, storing and operating the ET five-dataspace model and is realized in the following manners:

(1) Filtration ET Pick Up Method:

a filtration ET pick up method refers to a method of processing corresponding ET models by mapping ET deriving model and a process is ET deriving of the ET deriving model by a computer graphic identification technology and comparison, identification and judgment of shapes and positions between the ET deriving model and the to-be-screened models.

The ET deriving model refers to an ET live-dataspace model mapped according to a provided standard parameter and is taken as a standard for identifying a target ET model.

The ET deriving refers to a process of ET deriving of the ET deriving model according to a provided standard parameter.

(2) Grid Pick Up Method:

a grid is established in the X-Y-Z space, so as to efficiently identify the ET five-dataspace model stored in the space in one or more manners of colors, postures and X-Y-Z coordinate values, which is as shown in FIG. 16; and

(3) Early-Warning Element Space Pick Up Method:

a mathematical function is inducted by early-warning element postures of the ET models, and art early-warning element space is mapped in the X-Y-Z space, so as to classify and pick up the ET models.

0-1-4.2-2.2-2.2-3.3-0: ET Scanning

The ET scanning refers to a process that the ET information is detected, searched, identified, classified and stored by a computer logical operation (including but not limited to operation of 0 and 1), and an obtained application level ET model set regenerates an ET model set or an ET model space according to the functional requirement, and the output of the ET scanning is an ET time-geography-color space.

The ET time-geography-color spare (ET TGCS) refers to an information transmission manner which provides a decision-making analysis and can visually show the quality evaluation/perception degree by the ET scanning or other data mining technologies of the ET information, and the ET TGCS is a implementation manner of an augmented reality technology.

0-1-4.3-0: the ET information is based on traceability quality perception information and comprises the collection level ET information, the acquisition level ET information, the storage analysis level ET information and the output level ET information.

The collection level ET information refers to: a group of information conductive to quality analysis and early warning, which conforms to measurementized or digitized regulation, has a condition of acquiring time domain parameters in real time (longitude and latitude coordinate values and triggering time points) and is beneficial for detection and transmission.

The acquisition level ET information refers to that the collection level ET information is dimensioned and quantized according to a metric conversion mechanism, the information is stored in the ET five-dataspace model according to a graphic transformation mechanism, and a man-machine interface or an interface standard belongs to the acquisition level ET information, such as the ET pointing interface (as shown in FIG. 14).

The storage analysis level ET information refers to: a response result or process of various graphics, vector axes and parameters in the process that the ET system executes information processing and analysis such as the ET five-dataspace model and various parameters, the posture of the ET five-dataspace model in the dataspace, a five-dataspace model set array rule, the ET per.dem, the ET early-warning element function curve, the ET TGCS and the like.

The output level ET information refers to: a mechanism of transmitting the information processed and analyzed by the ET system to demanders and comprises an ET five-dataspace model pattern, additional information and intercepted or scalable modeled data information.

It is particularly indicated that:

the output level ET information can be converted according to a certain computer graphic identification technology, so as to enhance the visual effect, for example, decision information can be more clearly conveyed by color saturation, brightness or chroma and the like of a dot matrix of a unit display interface, and the converted statistic data or information can be detailedly viewed and analyzed by scalable longitude and latitude or the time axis system.

0-1-4.4-3: the high-efficiency management comprises input management, output management and process management.

0-1-4.4-3.1-0: the input management refers to: a group of technologies and activities that the ET information is collected, acquired in a time domain datamation manner by hardware conditions such as the ETAPP, a special passageway, an intelligent detection sensing technology and the like and is transmitted to an acquisition interface port of the ET system by a communication technology;

0-1-4.4-3.2-0: the output management refers to: a group of technologies and activities that ET information is issued by the ETAPP, a special passageway, a high resolution display (outdoor or indoor) and other traditional media terminals accessed by the ET information platform, wherein for the display and transmission of the outdoor or doorplate ET information, the ET system appoints that a human-computer interface is wirelessly controlled by a display interface program and the ETAPP, so as to achieve the purpose of wireless control for an ET information interface (such as: amplification, narrowing or other searching operations); and

0-1-4.4-3.3-0: the process management refers to: a group of technologies and activities that the. ET system carries out modeling acquisition, storage and analysis on the ET information. The integration of the above input, output and process management is summarized as a technical form of the ET system, which is shown in FIG. 28.

### BRIEF DESCRIPTION OF DRAWINGS

FIG. 1 is an spp theoretical framework;

FIG. 2 is an ET five-dataspace model (a logical model diagram);

FIG. 3 is a goods dataspace;

FIG. 4 is an evaluate dataspace;

FIG. 5 is a production dataspace;

FIG. 6 is a process dataspace;

FIG. 7 is a system dataspace;

FIG. 8 is a PgA@ (perception);

FIG. 9 is characteristic element identification for a PgA@ (perception);

FIG. 10 is a PgA@ (perception) plane;

FIG. 11 is a logical analysis on an evaluation process (taking a goods Ea as an example);

FIG. 12 is an ET five-dataspace evaluation display model (a lotus diagram, taking evaluations of consumers as an example);

FIG. 13 is an ET five-dataspace model (a conceptual diagram);

FIG. 14 is an ET pointing interface;

FIG. 15 is an ET information collection and expression rule (a goods dataspace and a production dataspace);

FIG. 16 is an ET information collection as d expression rule (a process dataspace and a system dataspace);

FIG. 17 is an evaluation dimension display logic (taking evaluations of consumers as an example);

FIG. 18 is an ET information acquisition and measurement rule (a goods dataspace and a production dataspace);

FIG. 19 is an ET information acquisition and measurement rule (a process dataspace);

FIG. 20 is an ET information acquisition and measurement rule (a system dataspace);

FIG. 21 is an evaluation dimension graphic display logic rule;

FIG. 22 is an evaluation dimension graphic logic (taking evaluations of consumers as an example);

FIG. 23 is an ET information storage logic (per.dem of a model posture relationship axis);

FIG. 24 is storage logics of different characteristic element models;

FIG. 25 is a logic diagram of a relationship axis (a model set array diagram);

FIG. 26 is an automobile abnormal noise array diagram;

FIG. 27 is an automobile abnormal noise array diagram (local);

FIG. 28 is black and white of a technical form of an ET system;

FIG. 29 is an information processing logic structure of a PgA@;

FIG. 30 is an ET body temperature map operation logic (taking a Wenchuan earthquake region as an example) (overall);

FIG. 31 is an ET body temperature map operation logic (taking a Wenchuan earthquake region as an example) (local);

FIG. 32 is an ET body temperature map operation logic (taking a Wenchuan earthquake region as an example) (local details);

FIG. 33 is an ET number mark;

FIG. 34 is an ET authentication mark;

FIG. 35 is an acquisition, conversion and authentication mechanism of an ET for traditional internet information; and

FIG. 36 is a schematic diagram of an information acquisition solution of TandG intelligent sensor.

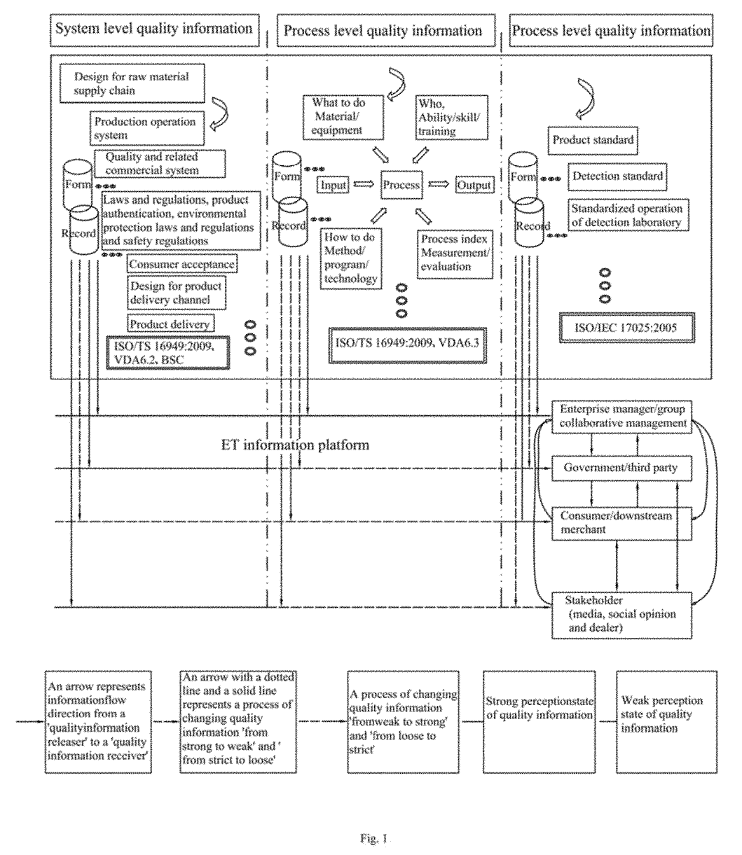

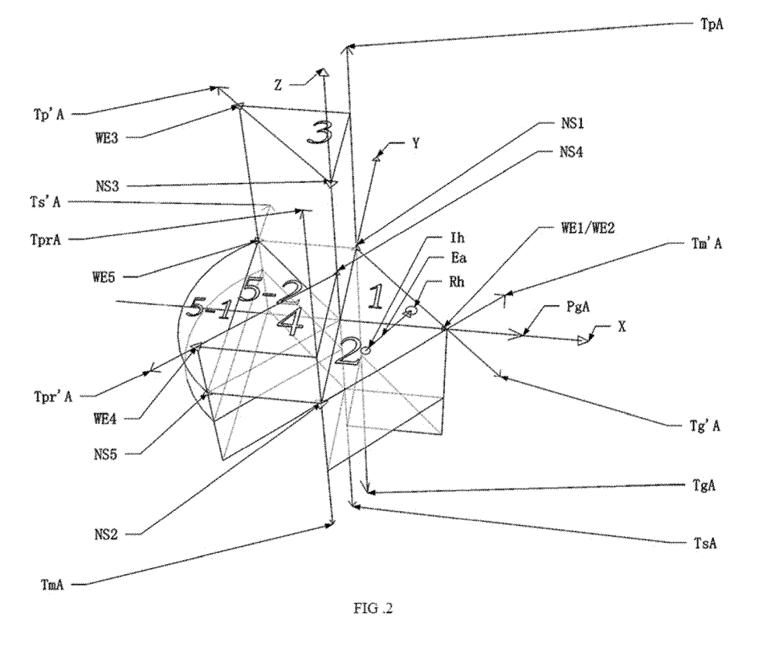

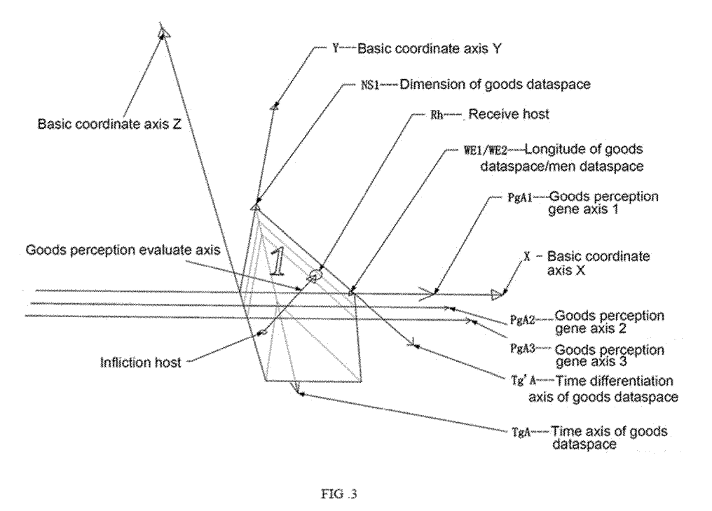

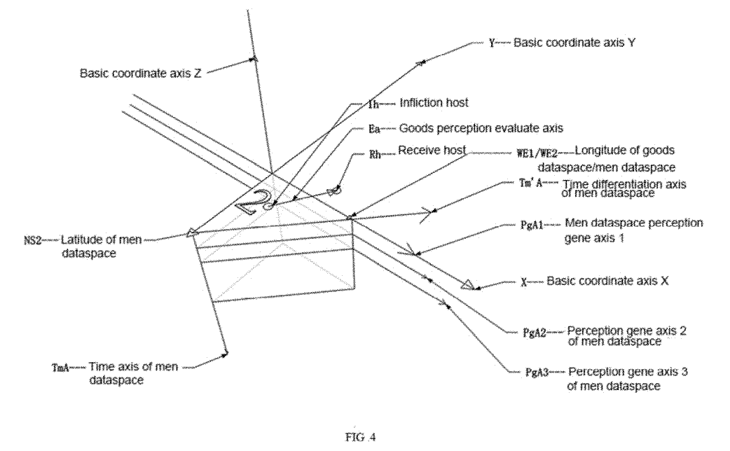

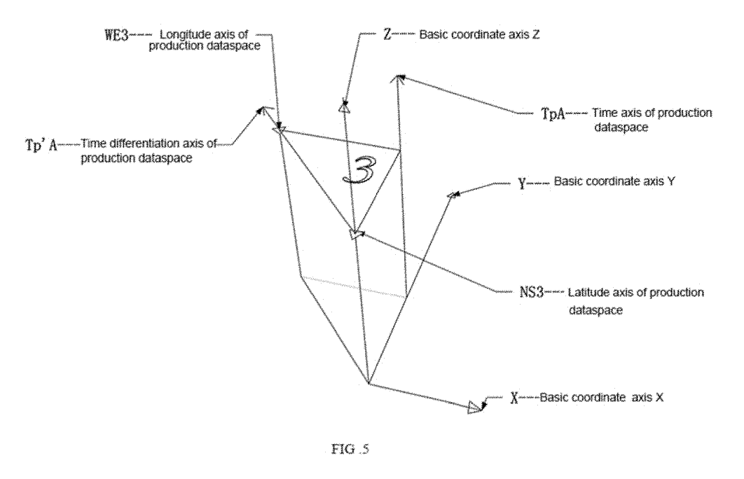

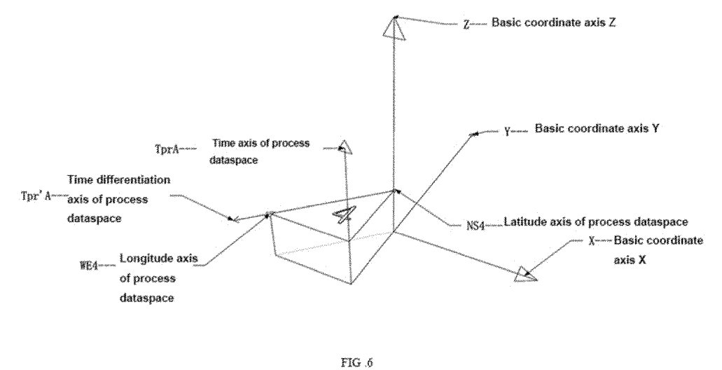

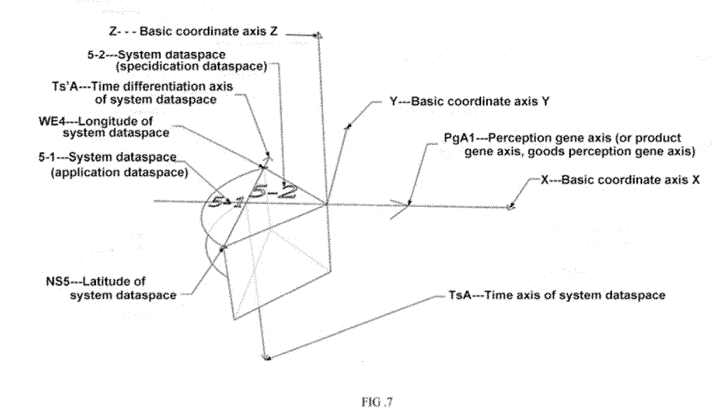

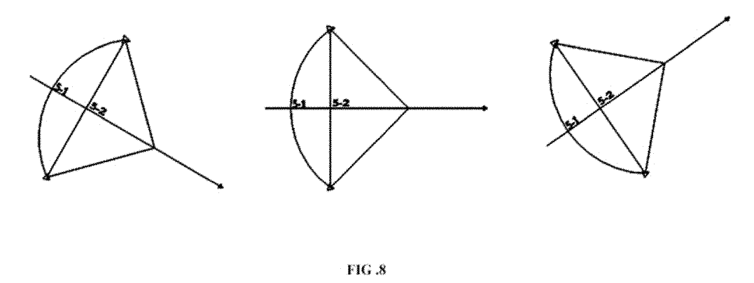

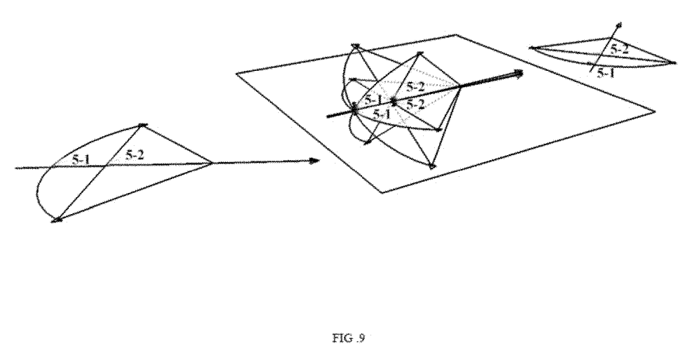

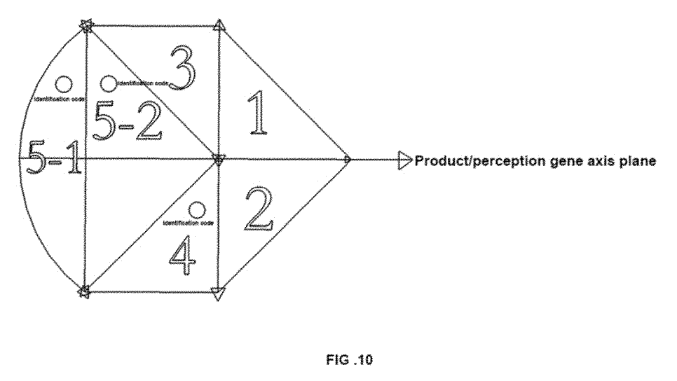

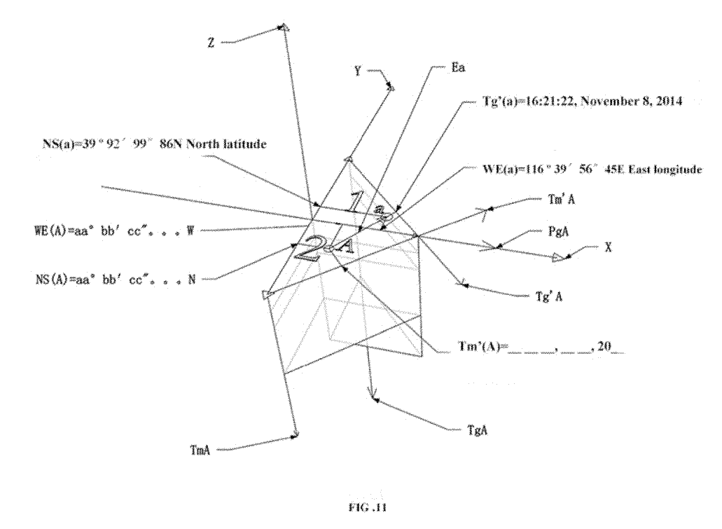

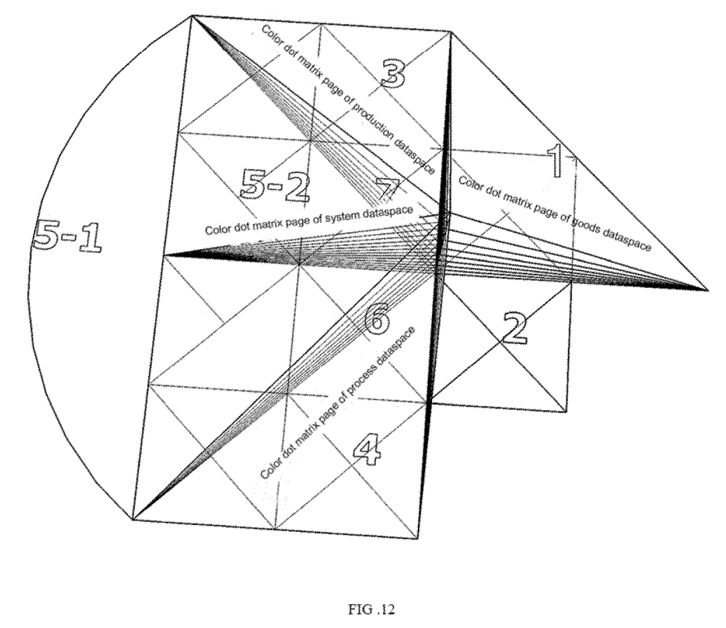

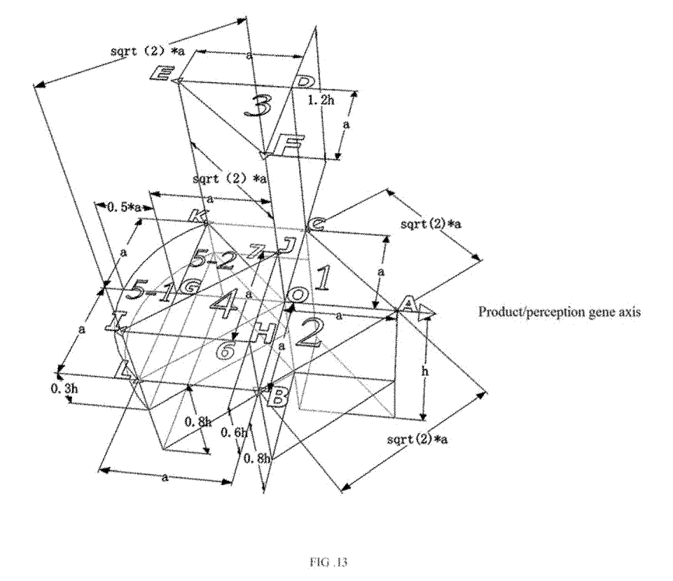

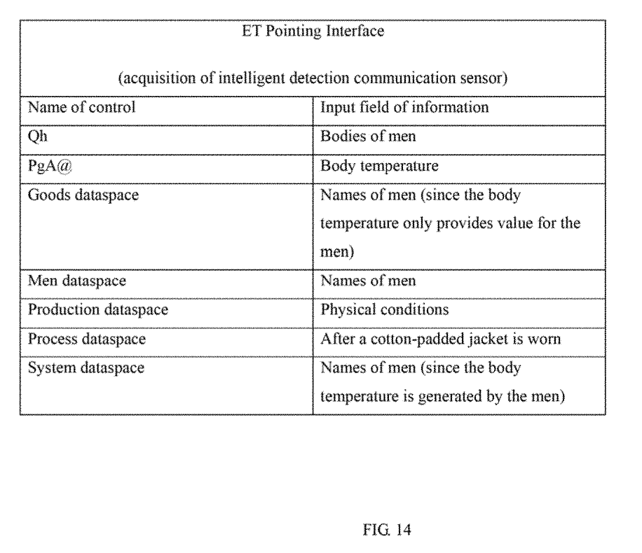

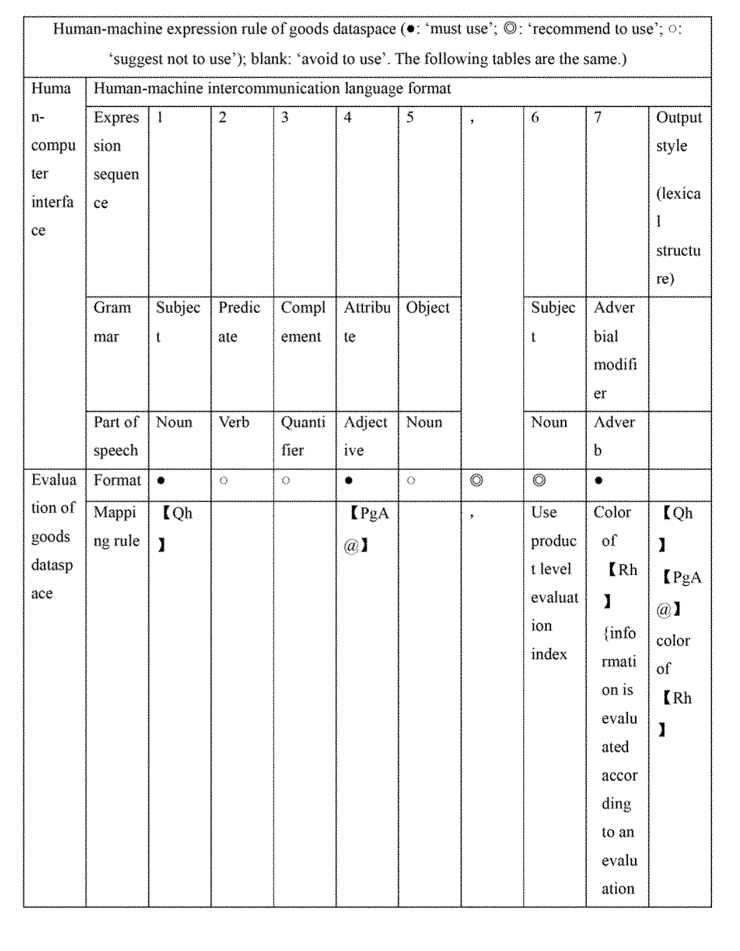

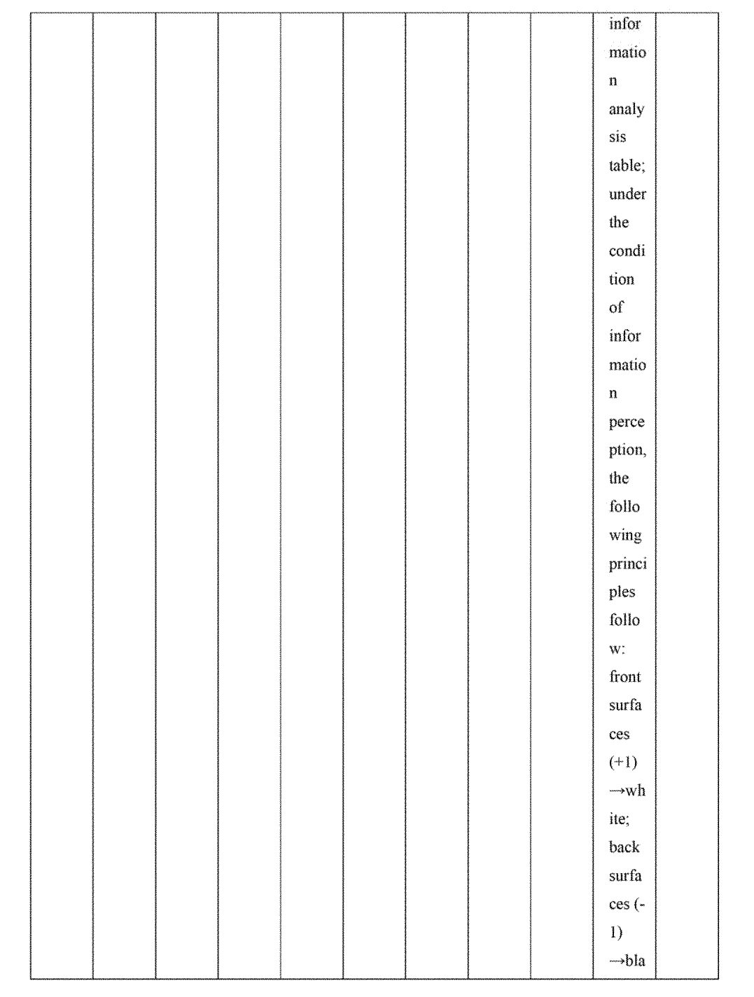

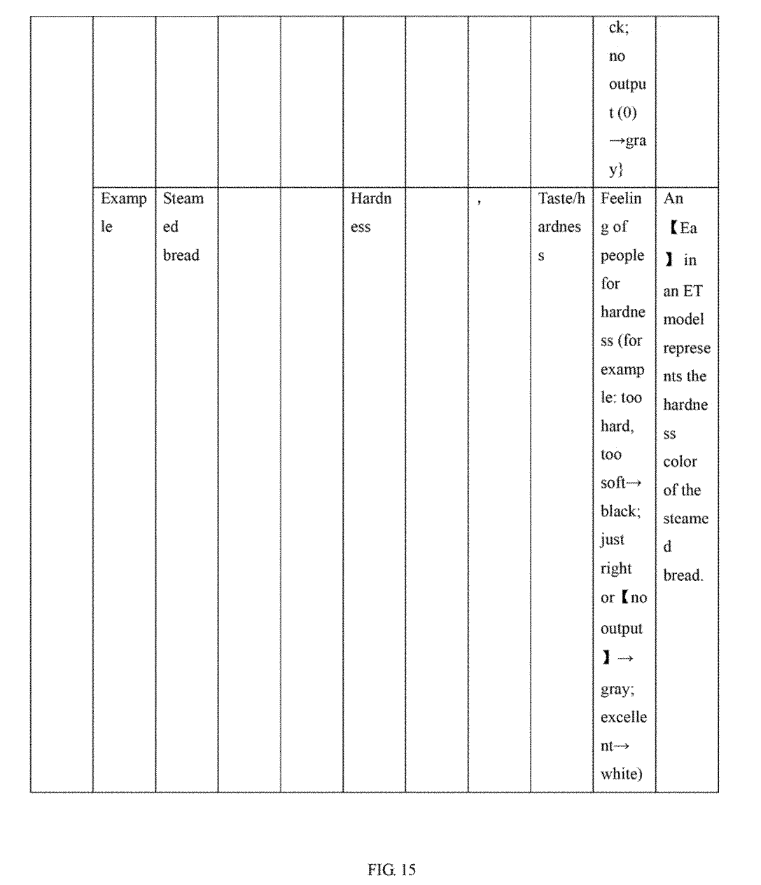

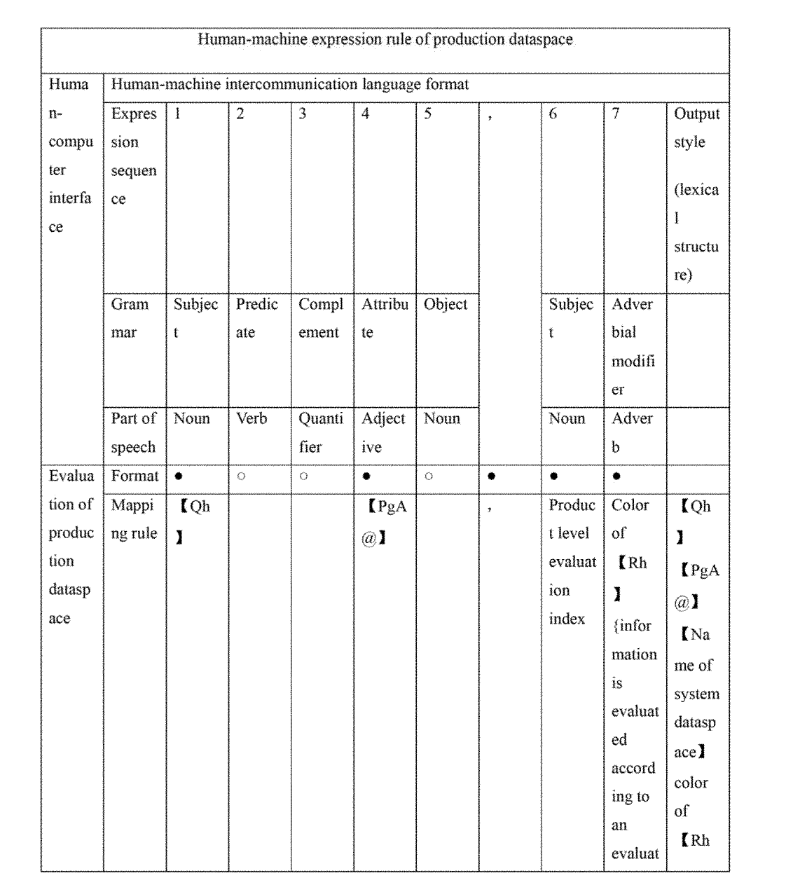

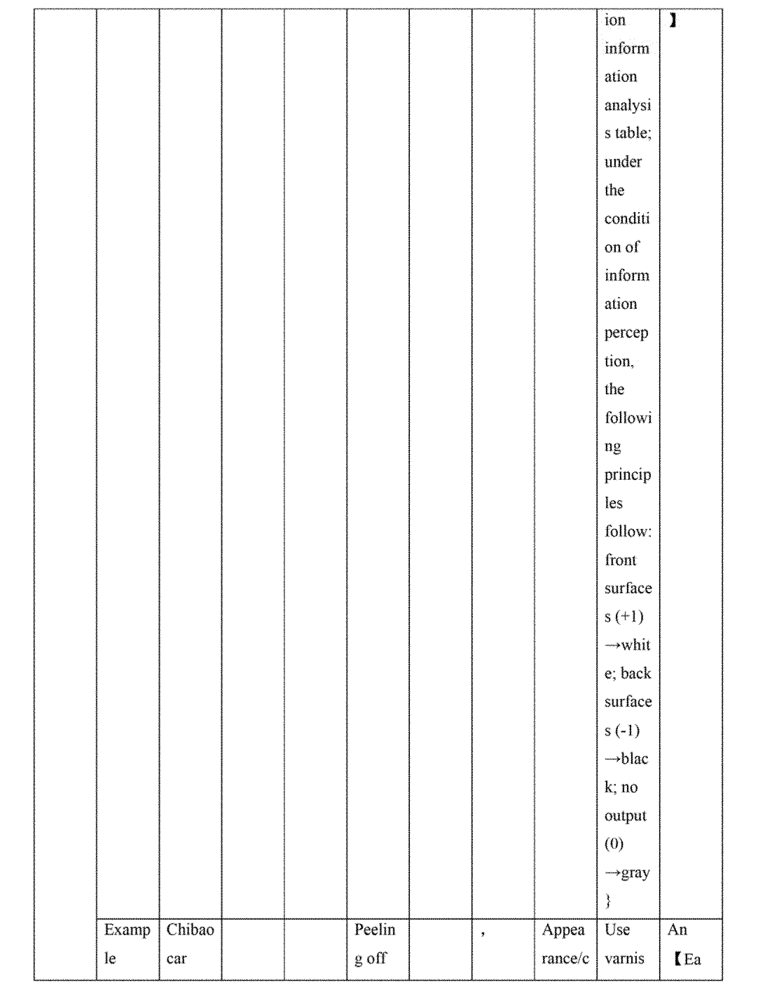

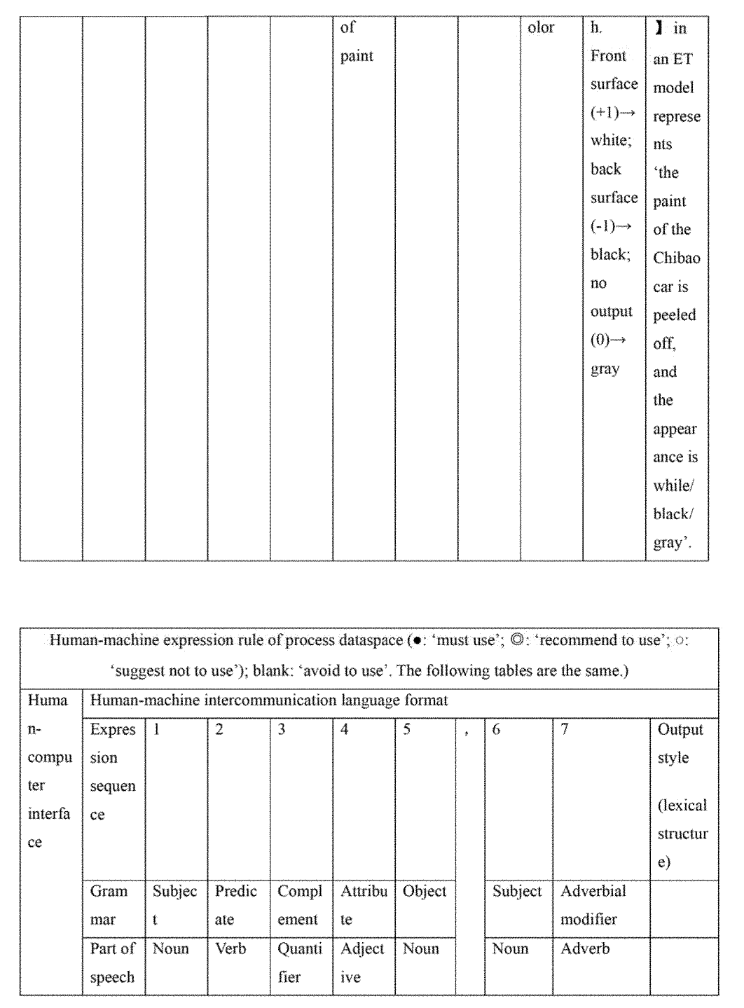

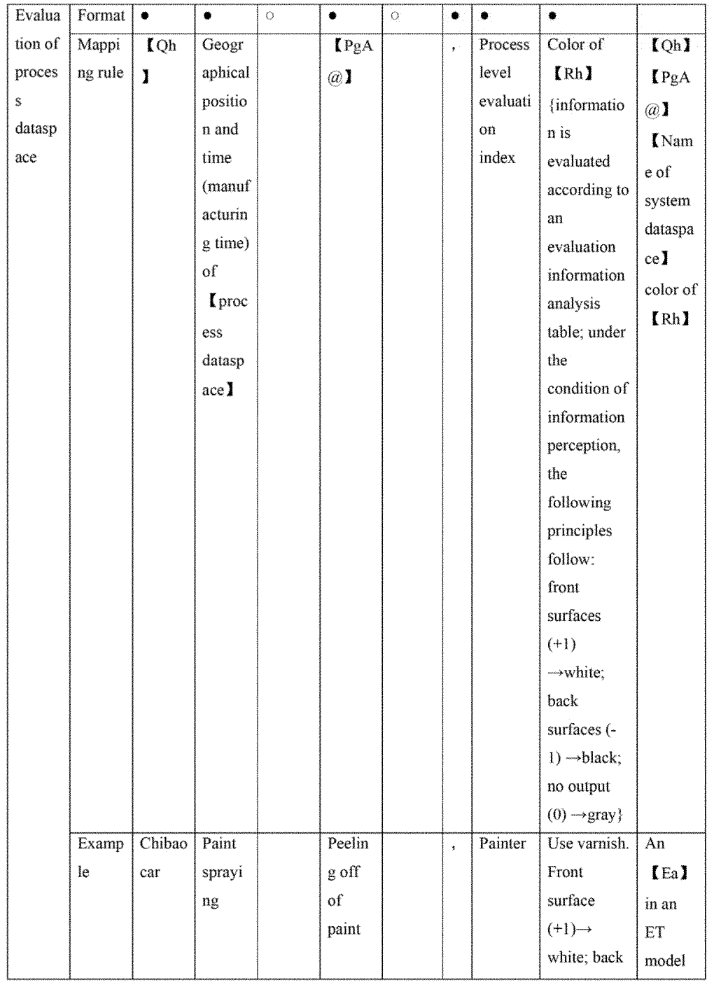

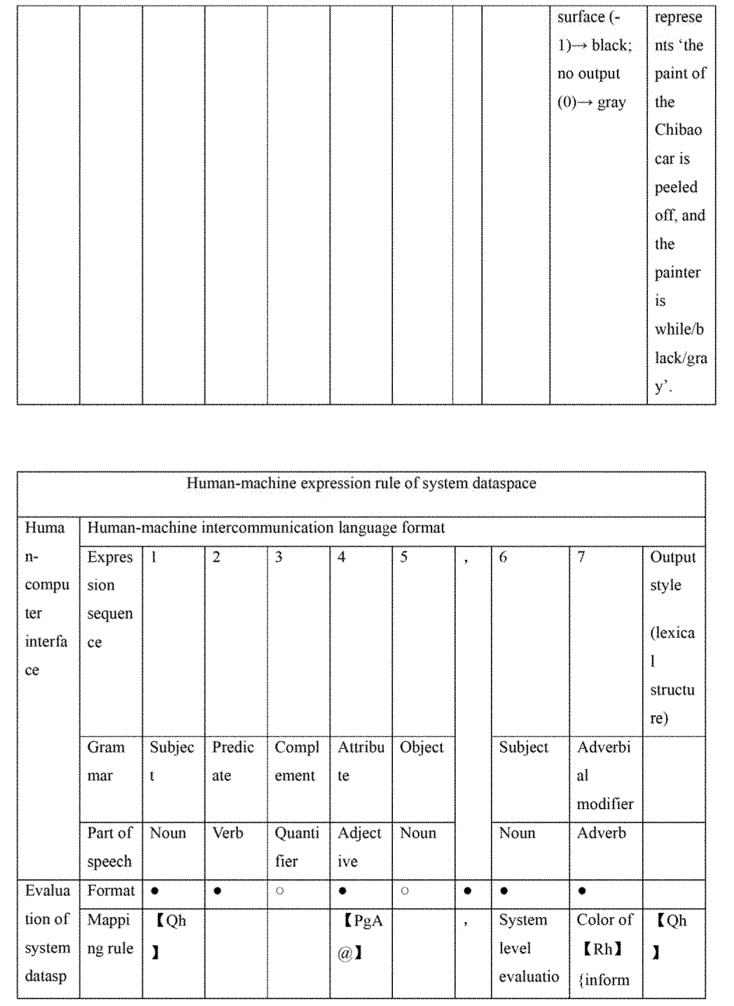

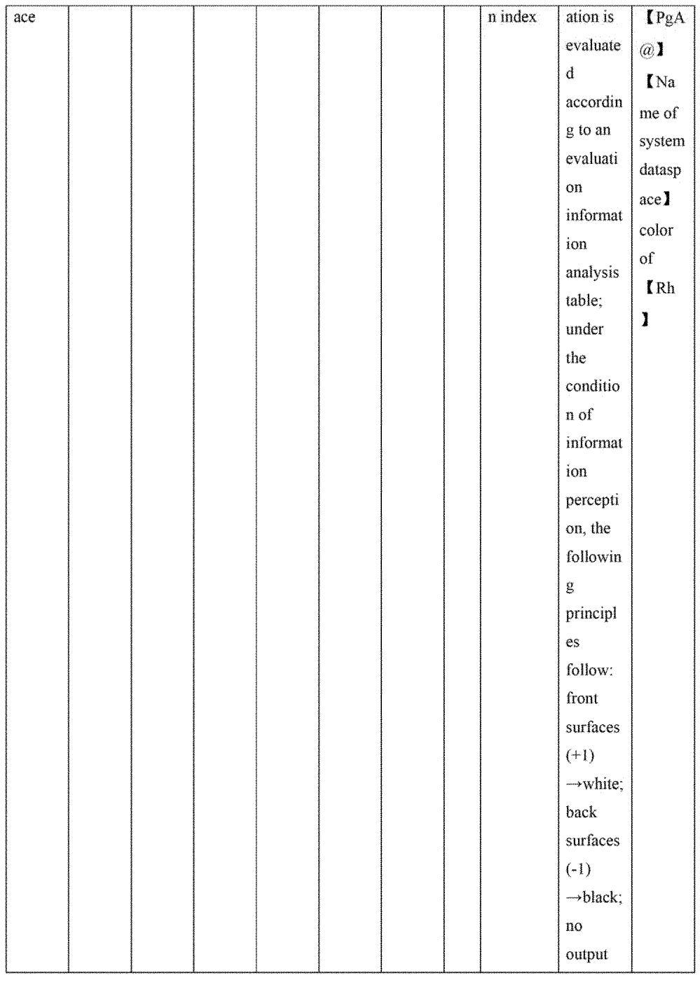

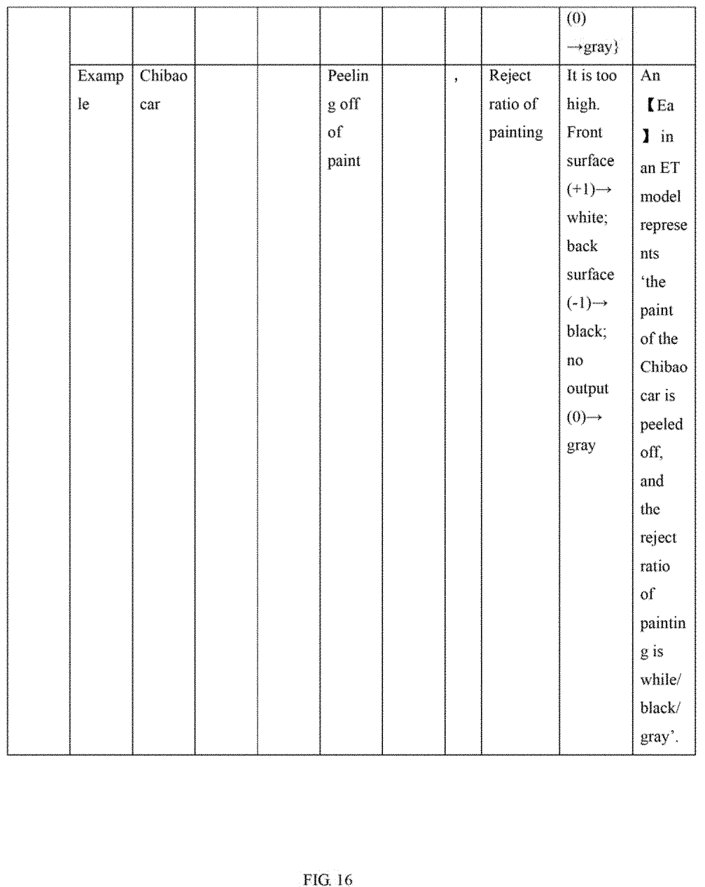

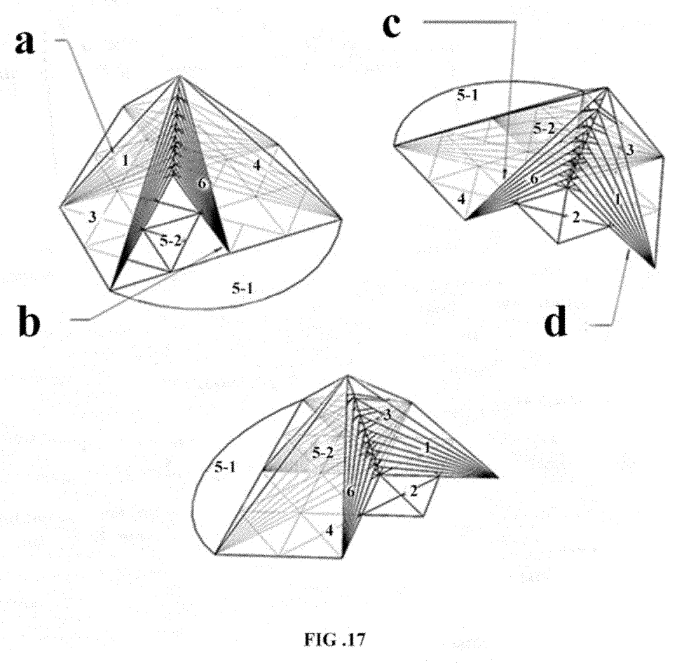

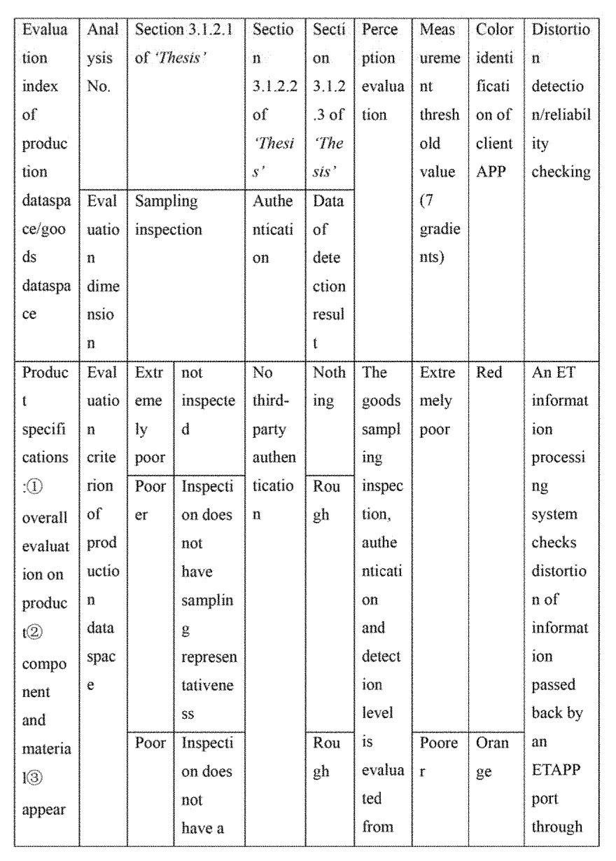

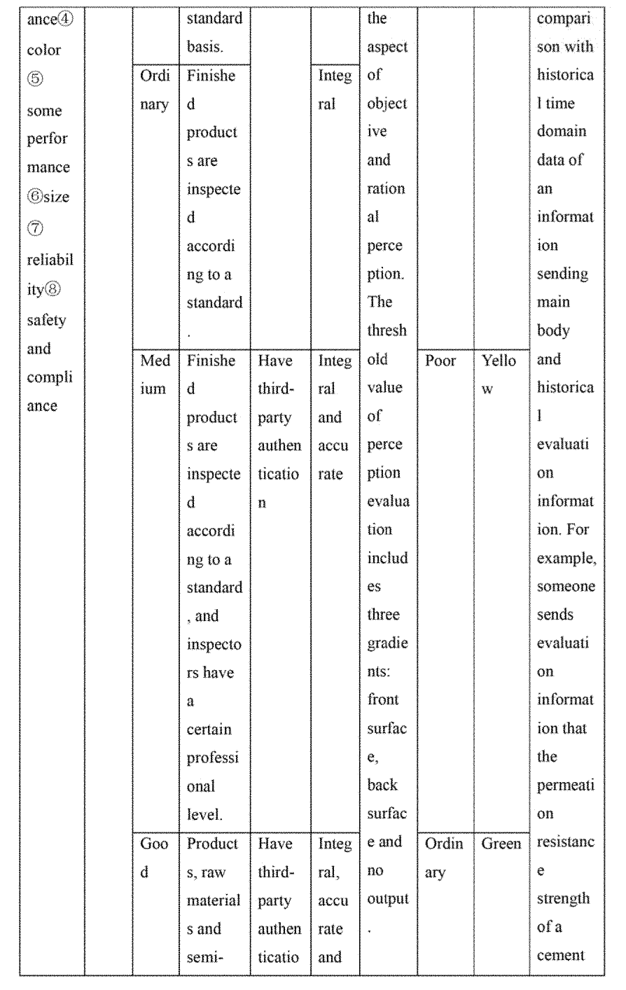

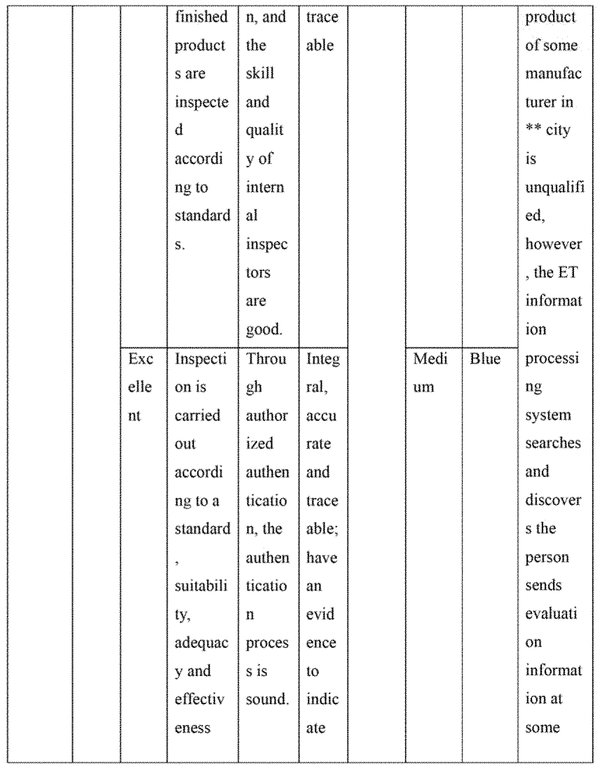

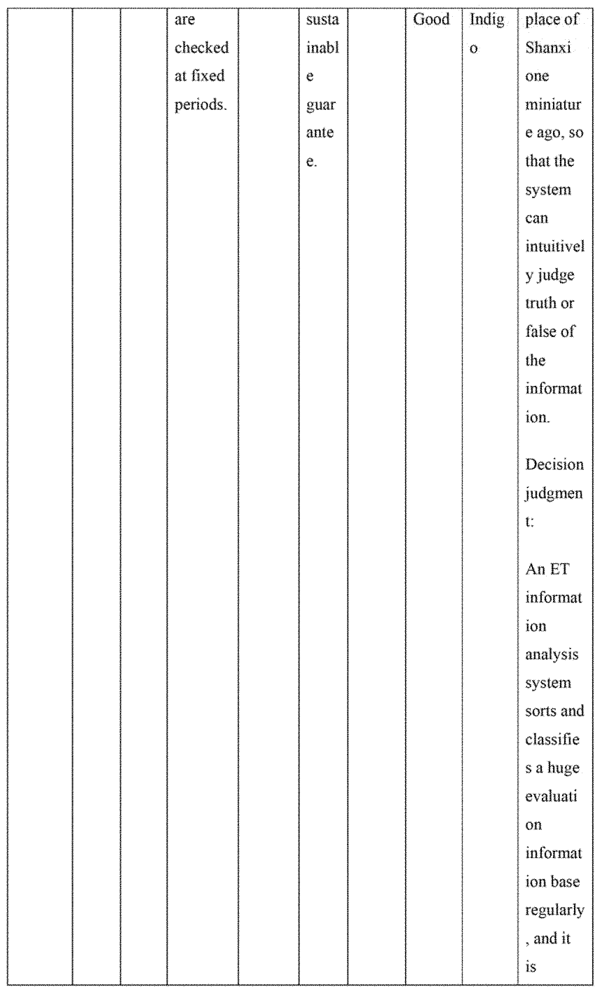

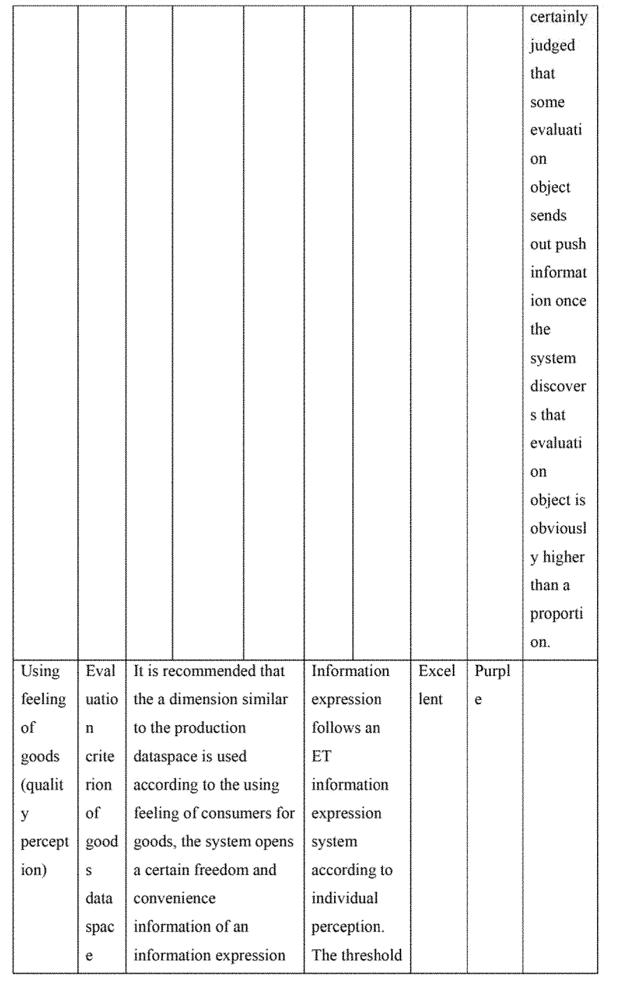

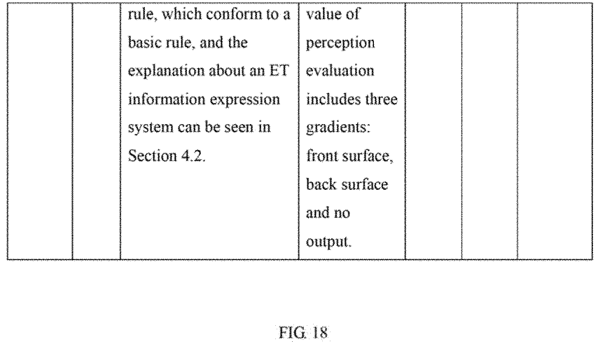

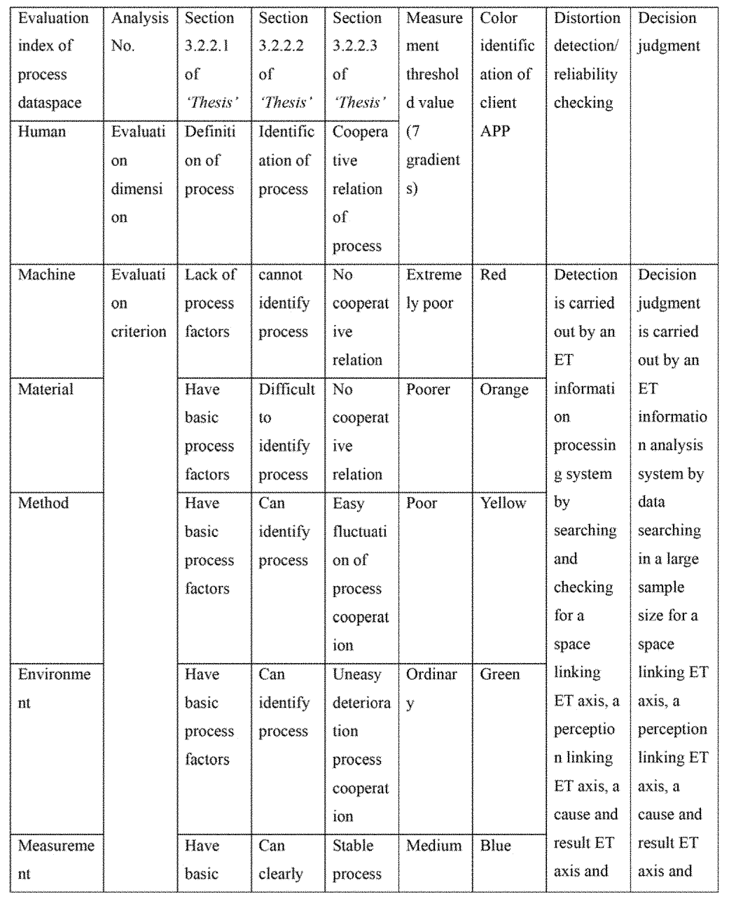

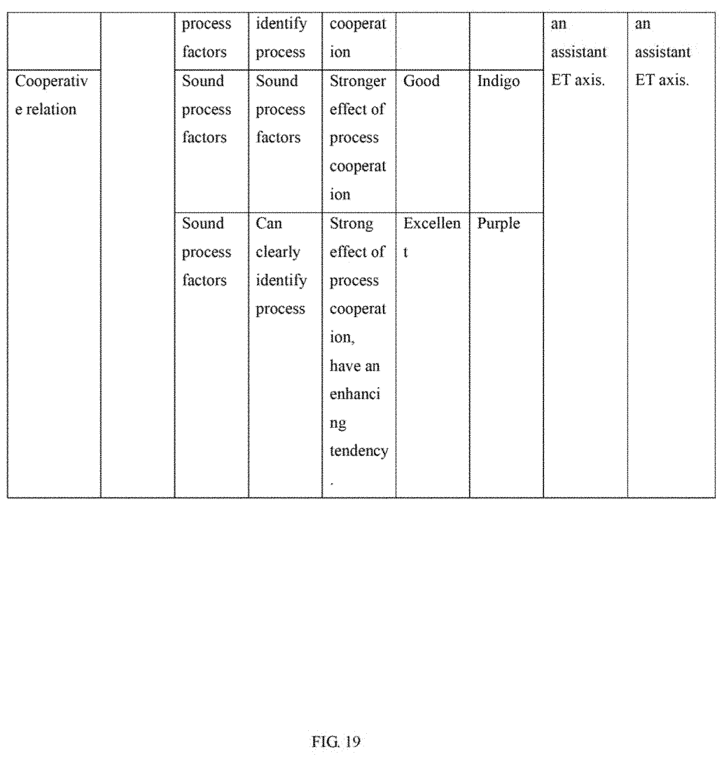

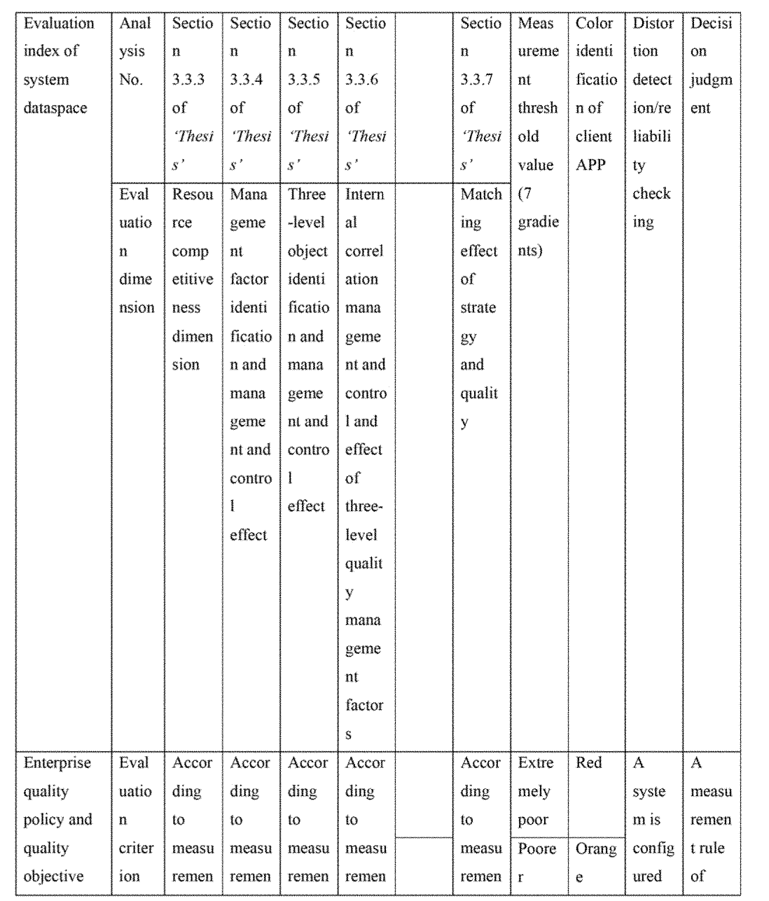

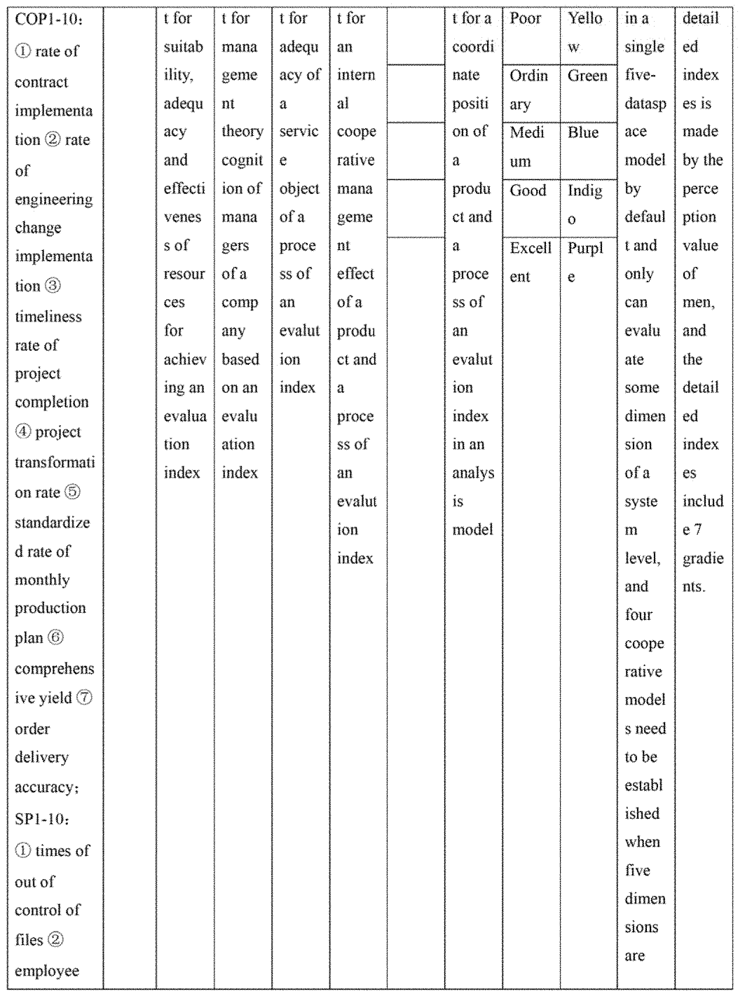

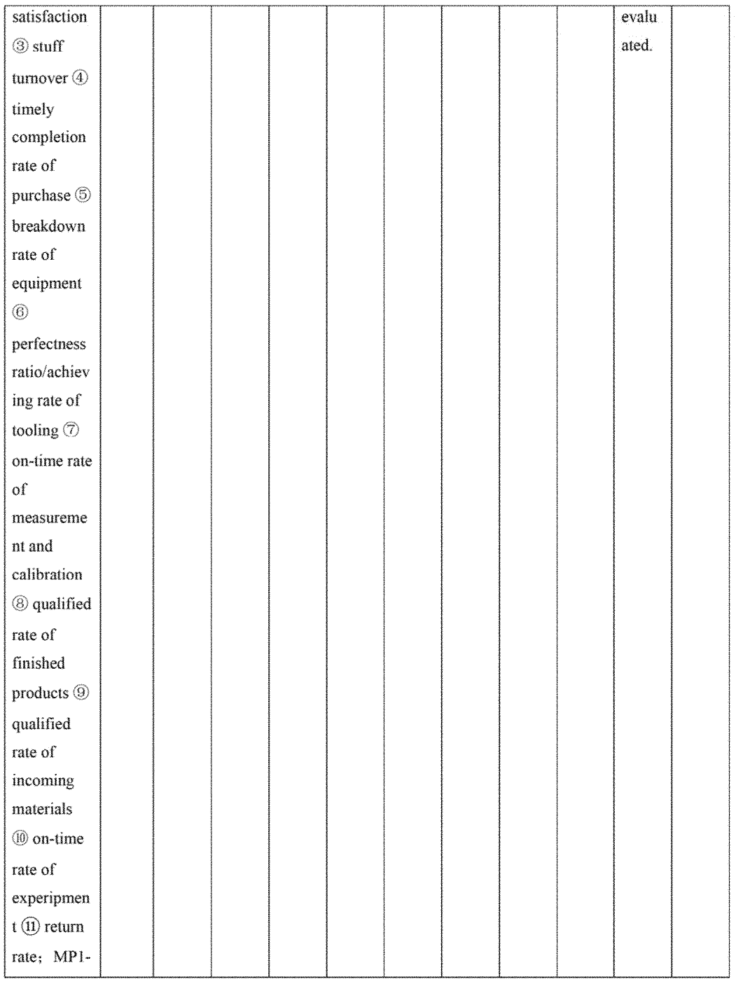

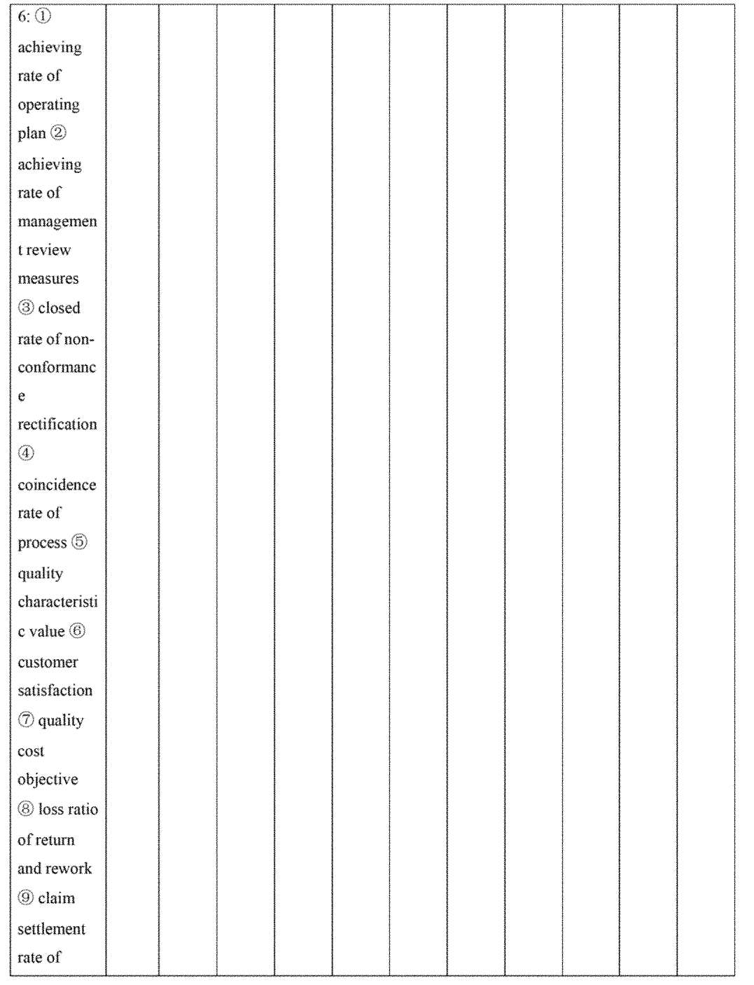

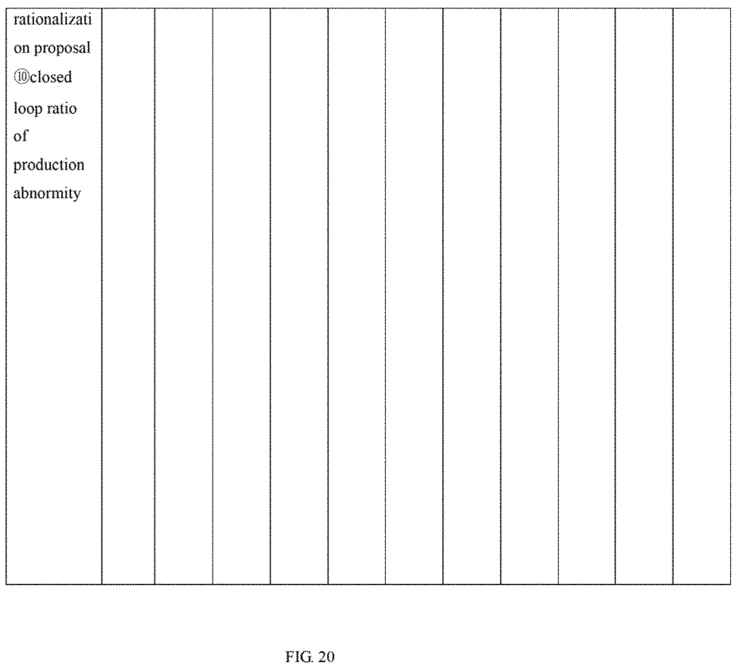

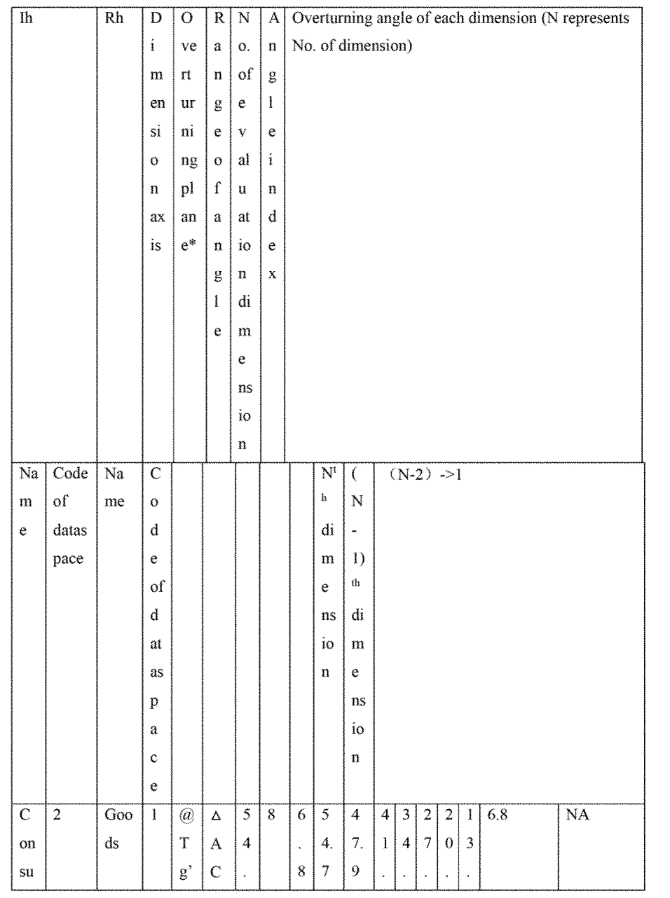

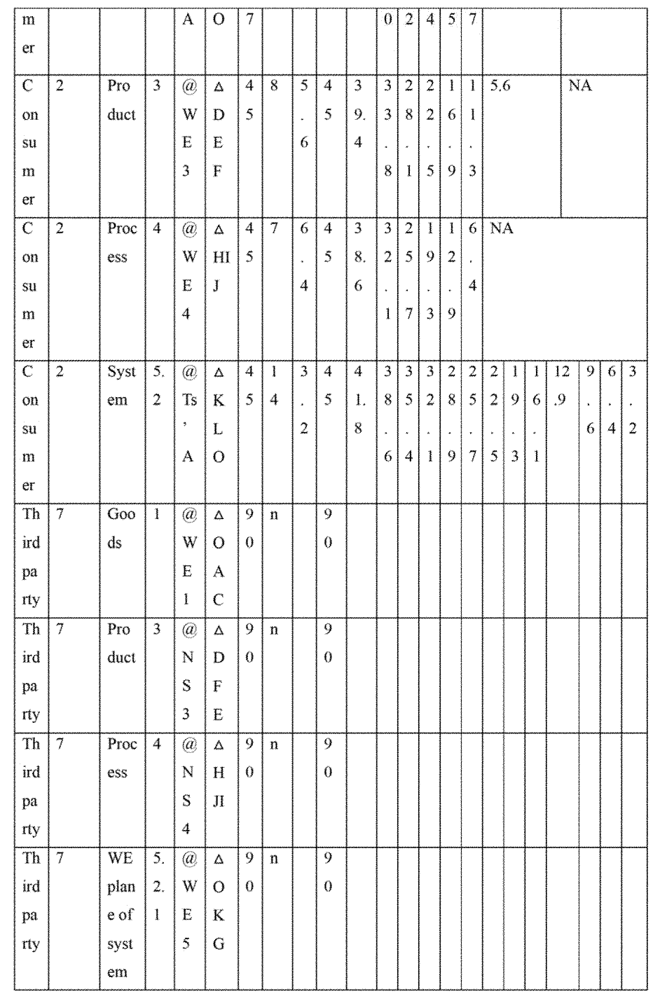

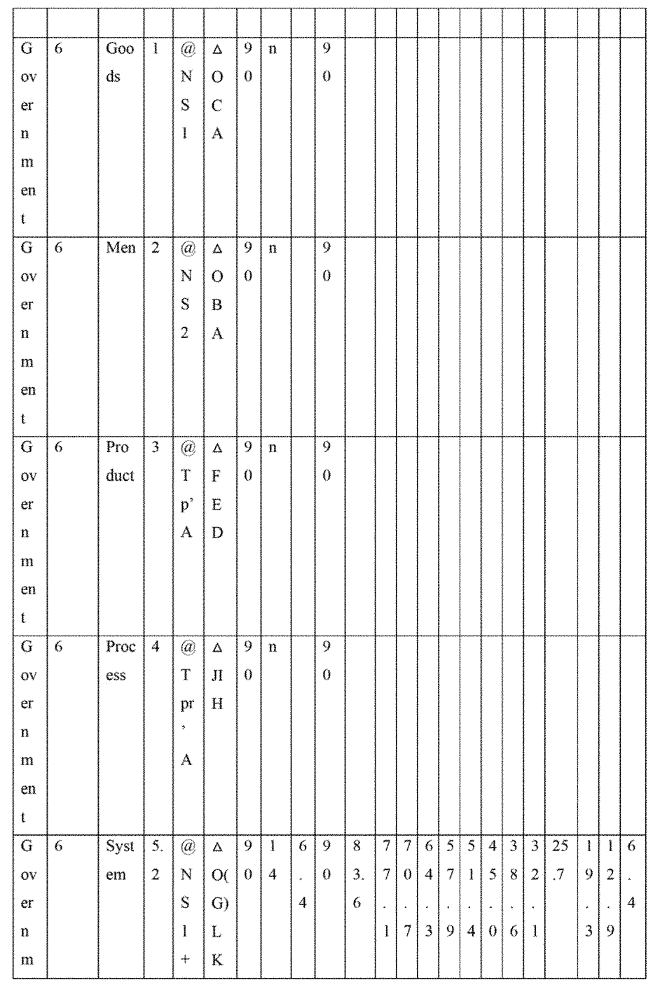

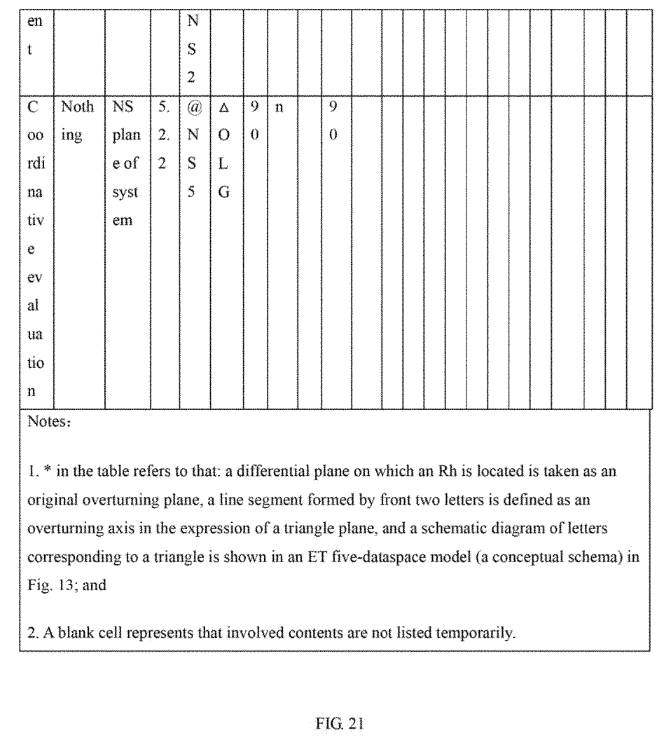

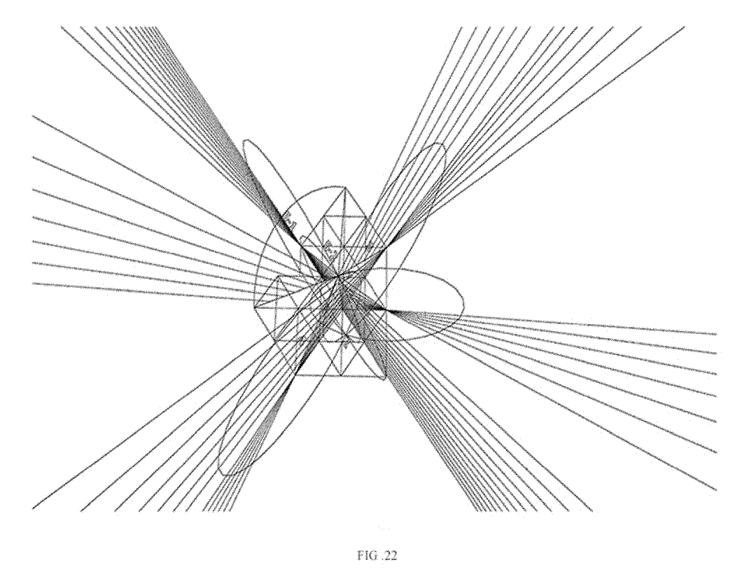

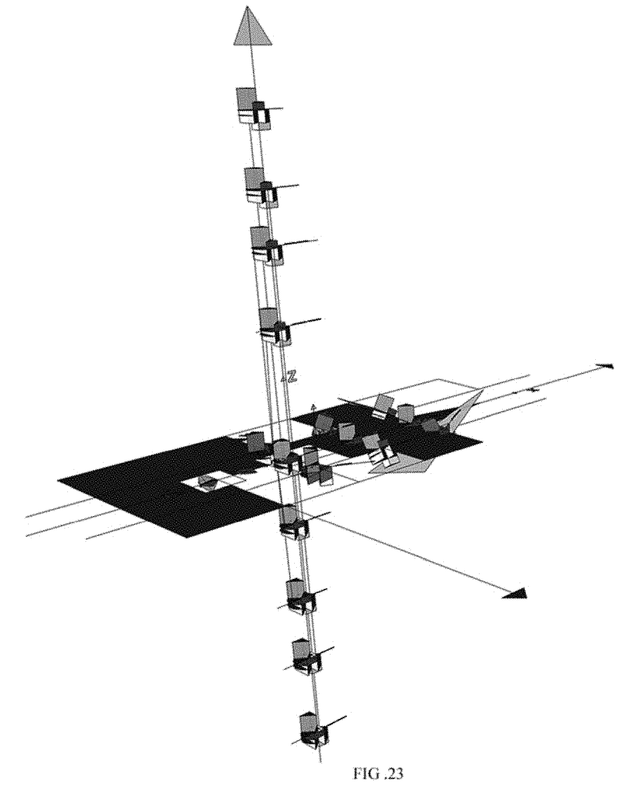

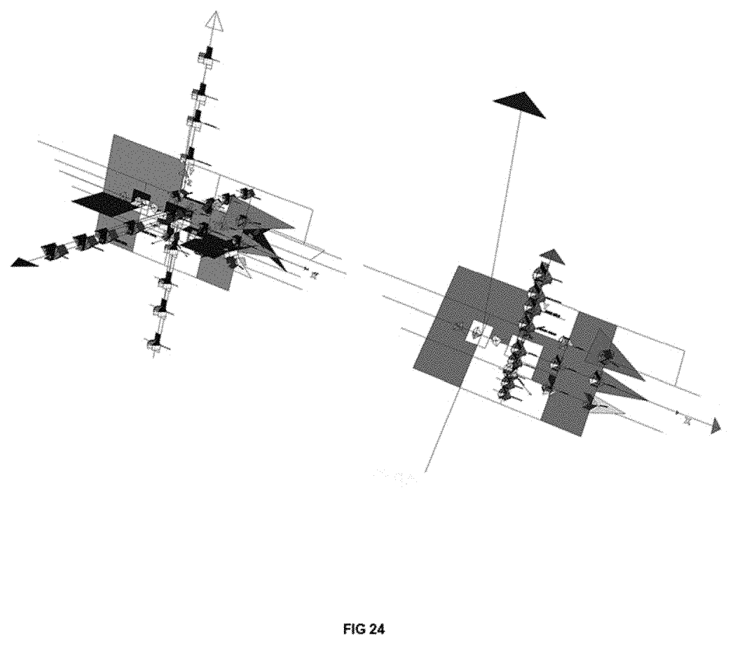

### DETAILED DESCRIPTION

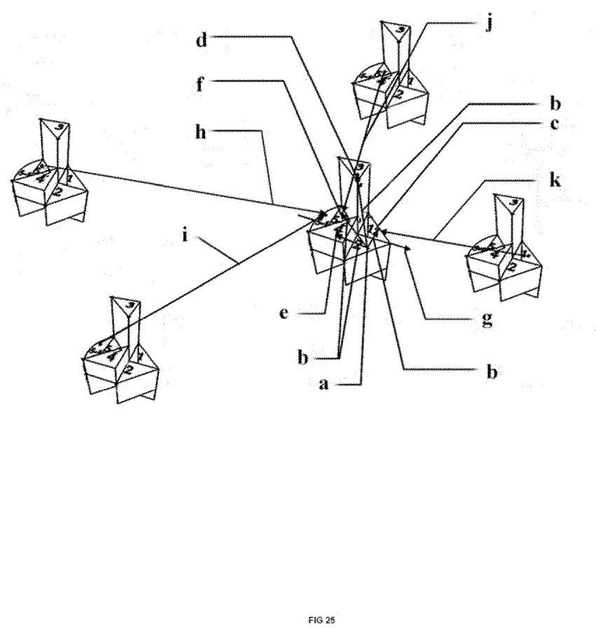

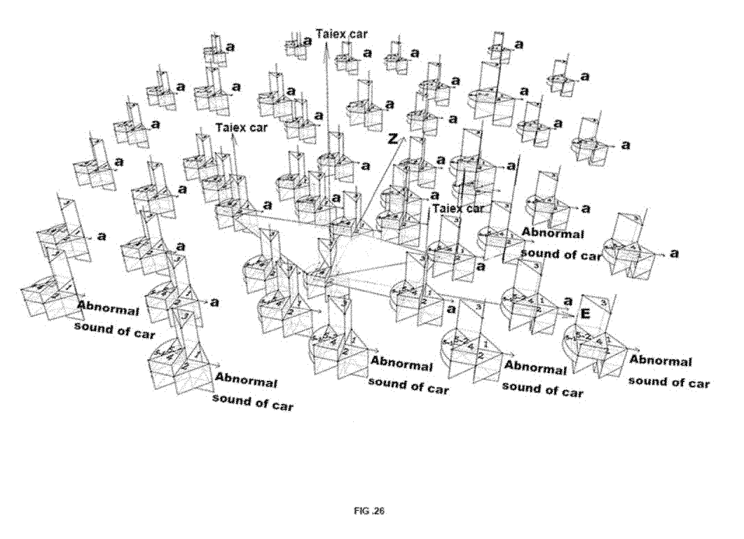

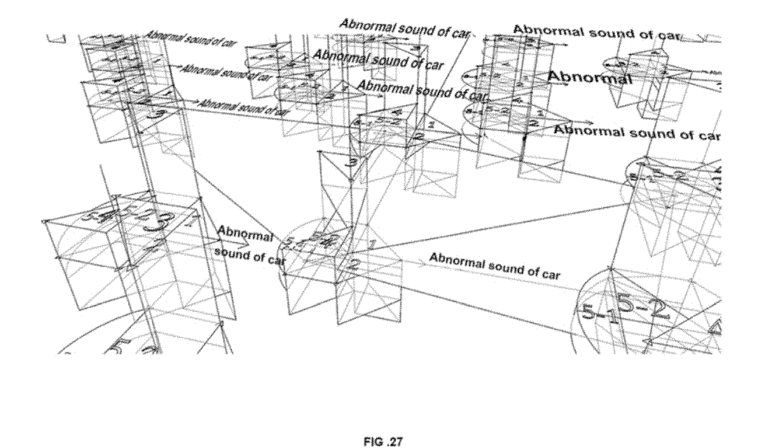

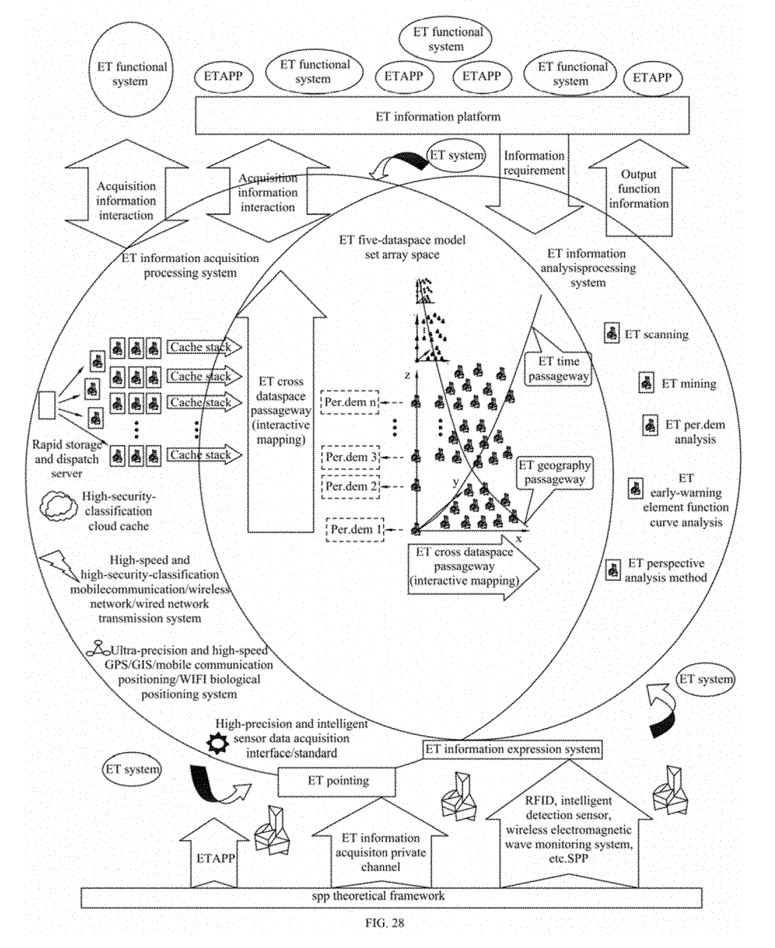

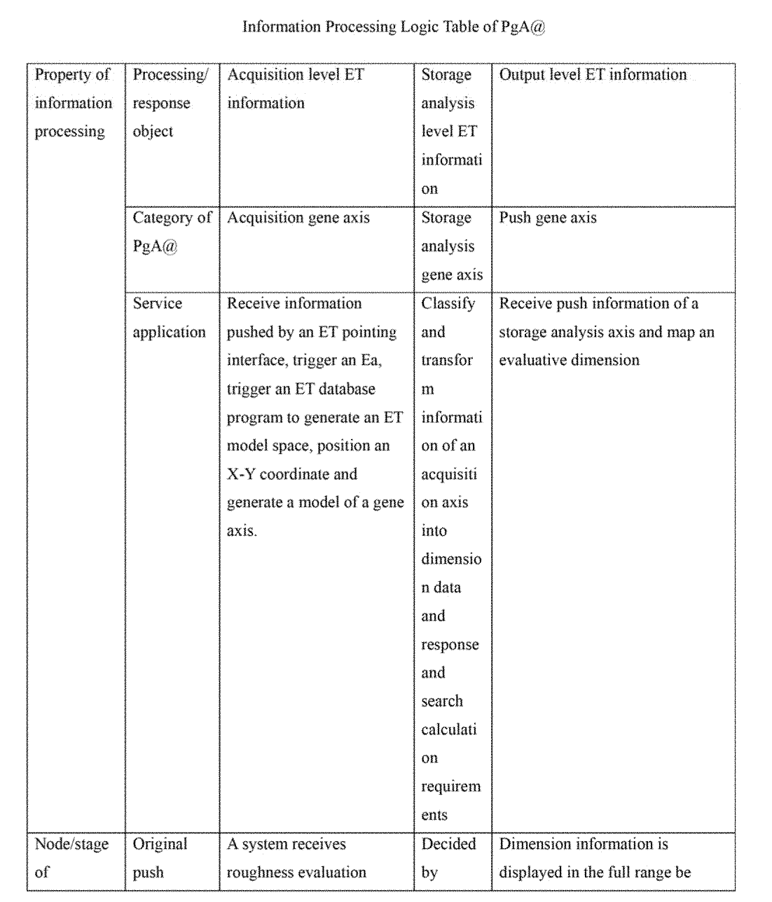

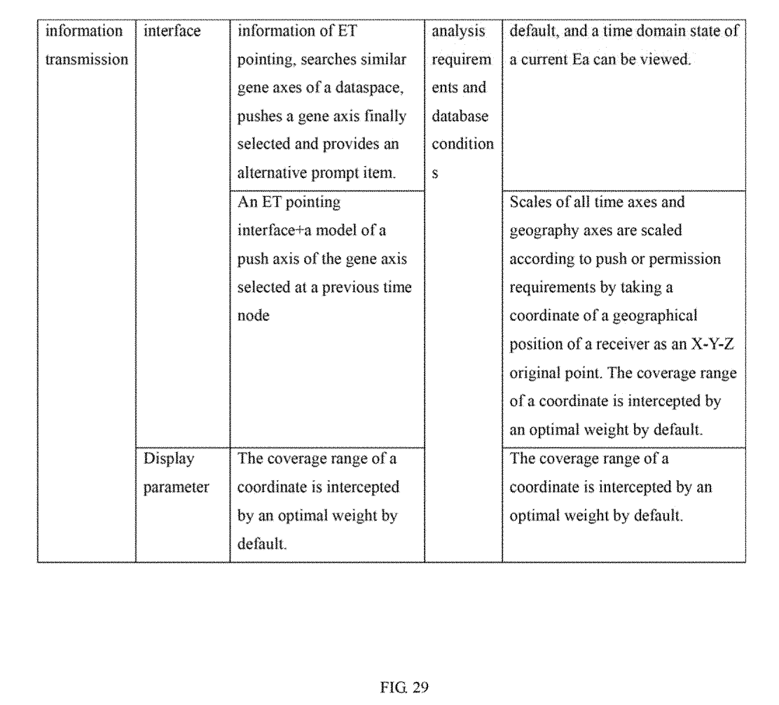

The functions of management methods and systems involved in the present invention comprise acquisition of perception/evaluation information, processing and analysis of the perception/evaluation information and transmission of the perception/evaluation information, implementation manners of the management methods and systems can be seen in a technical form of an ET system in FIG. 28, and a further implementation manner and description about the ET system can refer to the ‘Thesis’.

An implemented case about the present invention is described below, and the implementation steps and premise of the case have theoretical derivation and do not form the core content and a substantive query of the present invention.

Description of the Case:

An 8.0-magnitude great earthquake happens at Wenchuan County, Aba Tibetan and Qiang Autonomous Prefecture of Sichuan province (NS: 30°45′-31°43′; WE: 102°51′-103°44′) at 14:28:04 on May 12, 2008. In the earthquake, 69,227 people are died, 374,643 people are injured, and 17,923 people are missing; and the earthquake is an earthquake with the highest destructive power since the People's Republic of China was established and the most disastrous injuries and deaths after the Tangshan earthquake, the direct economic loss is RMB 845,200,000,000 Yuan, and the epicenter is located at the north latitude of 31.01° and the east longitude of 103.42°. Related national departments pay high attention to the post-disaster reconstruction work of the region, State Seismological Bureau strictly monitors strong earthquake regions and peripheral aftershock conditions, Centers for Disease Control and Prevention intensely carry out dispersion and prevention of post-disaster major infectious diseases, and International Red Cross combines the national psychological prevention and monitoring department to start a post-disaster emergency research and assistance work. Related departments agree that the strong earthquake in the region possibly brings a long-term serious psychological barrier for local residents and strongly suggest that the nation should attach importance and care to the health management work of the local residents, and one major proposal is that ‘whole-time-domain body temperature monitoring is carried out on the local residents, so as to ensure that the post-disaster psychology and the health of people are not influenced by the environment and the historical memory and are recovered.’

Some clothing brand has great interest in the proposal after hearing the proposal and says that the clothing brand makes a research on ‘influence of clothing colors on body temperature and psychology’; some global famous medical and pharmaceutical enterprise proposes that the enterprise makes a research on “influence of body temperature on representation of a body and psychology of a patient’ after hearing the proposal; National Aeronautics and Space Administration selects a batch of aerospace personnel entering International Space Station, but the harsh personnel body health index brings difficulty to the selection work, wherein a harsh index ‘about the stability of body temperature’ is prepared, but an effective means for proving that ‘the body temperature fluctuation condition can reflect the influence degree of external environmental noise and the environmental shock on human’ is not discovered; and National Earthquake Prevention And Disaster Reduction Committee makes a series of researches and proposes that before-earthquake creatures and omens of the natural environment are systematically researched and analyzed for the ‘Wenchuan Earthquake’, so as to provide a scientific and effective decision basis for later disaster prevention work.

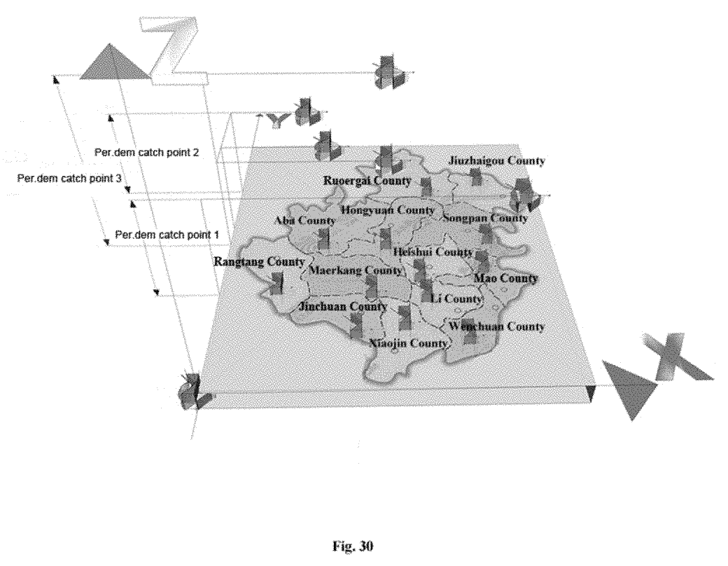

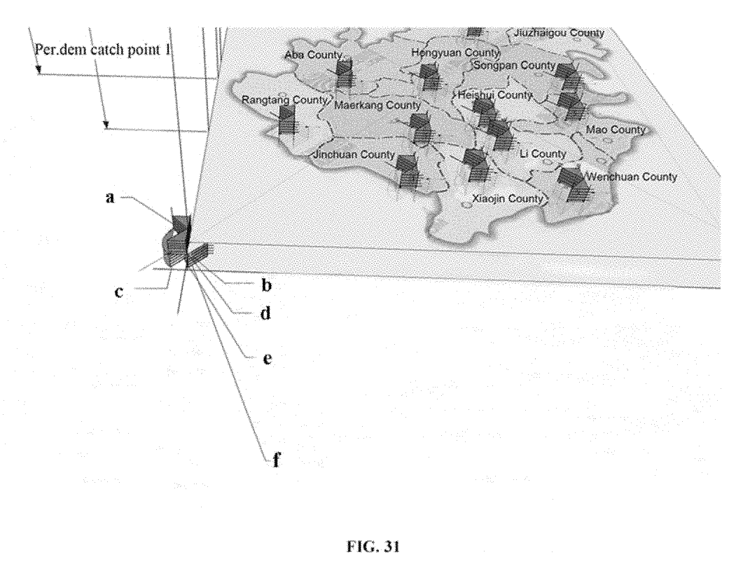

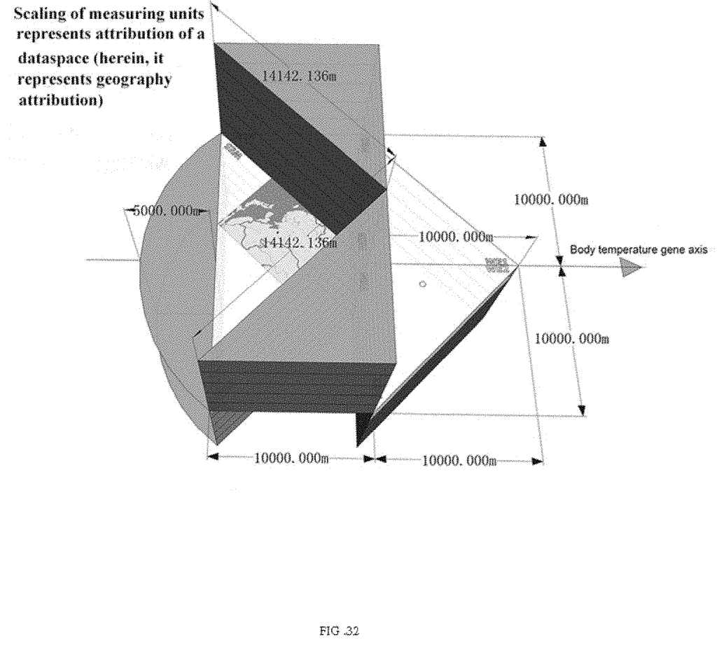

The proposals of the related departments obtain support and positive participation of all social, organizations, wherein Xiamen quality & technology service of easy-traceability Co., Ltd. also pays close attention to related situations of the ‘Wenchuan Earthquake’ and positively participants into implementation of the major proposal. The following scientific research and business work are implemented, and a body temperature monitoring map of the residents in Aba prefecture is monitored and realized, which is shown in FIG. 30 (FIG. 31 and FIG. 32 are partial enlarged views, as shown in FIG. 31, a represents that: goods dataspace→(designated as) monitoring metrics are recorded by 7 threshold values in an expression rule in the figure and are distinguished by color; b represents that: men dataspace→time domain changing track of body temperature monitored object; c represents that: production dataspace→a reference value is made for a real-time condition of mass data of body temperature at some longitude and latitude at that time on that day (the value is obtained by a computer according to historical data), so as to facilitate people to understand the position and the condition of the body temperature of the pople, particularly, a system gives an early warning element for various crowds and various processes, for example: mean body temperature of the population aged 0-3 is 36.5° C. and tolerance of fluctuation is ±0.4′C, mean body temperature of the population aged 4-16 is 36.8° C. and tolerance of fluctuation is ±0.4° C., mean body temperature of the population aged 17-50 is 36.9° C. and tolerance of fluctuation is ±1.5° C., mean body temperature of the population aged 51-75 is 36.5° C. and tolerance of fluctuation is ±0.6° C., mean body temperature of the population over the age of 76 is 36.5° C. and tolerance of fluctuation is ±0.4° C., regional index: mean body temperature of crowds flowing through the place in history is 36.4° C.; the, system reminds a monitored object of the situation that ‘the physical condition is threatened’ when the object, passes through the place with the instantaneous value of the body temperature higher than the mean body temperature; d represents that: process dataspace→auxillary temperature is monitored in a full time domain daily, and parameters of the process can monitor external factors influencing the change of the body temperature; e represents that: identification code of system-specification dataspace→one of residential health performance indexes represents that: body temperature; an axial inclination angle posture of an ET five-dataspace model can define various health performance indexes, such as weight, heart rate, blood pressure or other physiological properties, so as to provide a technical support for data processing for all-dimensional monitoring for the health indexes. f represents that: system-application dataspace→residents at Aba prefecture, Sichuan province, China.):

(1) A big data computing center is established, and a ‘Tianhe-2’ super computer is purchased and operated. for acquisition and analysis processing for ET information;

(2) A big data storage center is established, and one super memory is purchased and operated for coping with concurrence storage and response for a super-computing result;

(3) A GIS operation and maintenance center is established for improving satellite positioning and time service parameters with high reliability;

(4) A communication operation and maintenance center is established for wirelessly transmitting the ET information with high reliability;

(5) A research & development and manufacturing center of an intelligent detection sensor is established for being responsible for researching and manufacturing a hardware product such as a high-accuracy intelligent wearable sensor and the like, so as to detect perception information with high accuracy in real time;

(6) An operation and maintenance center of the ET system is established, and a set of high-reliability ET systems is developed for dispatching and operating the acquisition processing for the ET information, storage processing for the ET information (an ET five-dataspace model set array) and the analysis processing for the ET information; a set of ETAPPs is developed for acquiring counting-type and immediate-type perception/evaluation information; and a hardware data acquisition interface standard is developed;

(7) A traceability research center is established and includes a PgA@ research department, an information acquisition language and expression research department, a process influence research department, a macroscopic quality research department and a correlation mathematics research department (an ET early-warning element research laboratory and an ET information analysis research laboratory);

(8) A client right protection service center is established for providing full service and technical support for an ET information acquisition client;

(9) A project planning management center is established for planning and organizing a project and following up the effect of the project;

(10) An information security center is established for comprehensively managing and controlling information security, preventing distortion and unexpected use the information, and improving the reliability of an information system;

(11) An emergency processing center is established for coping with cross department communication work of an emergency event; and

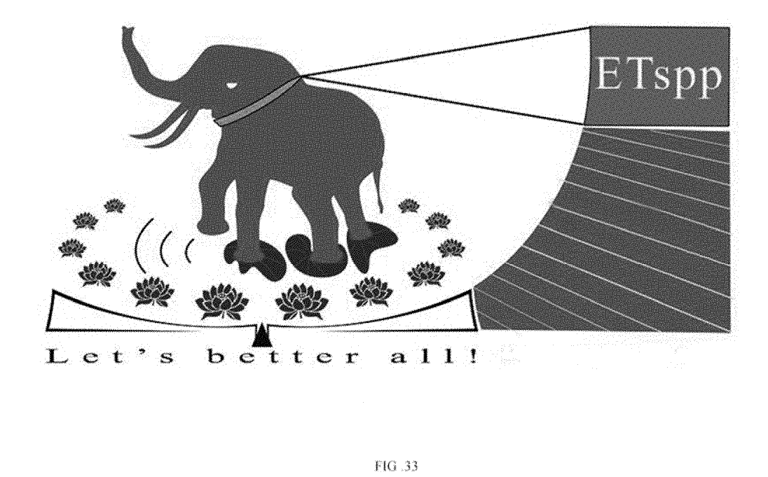

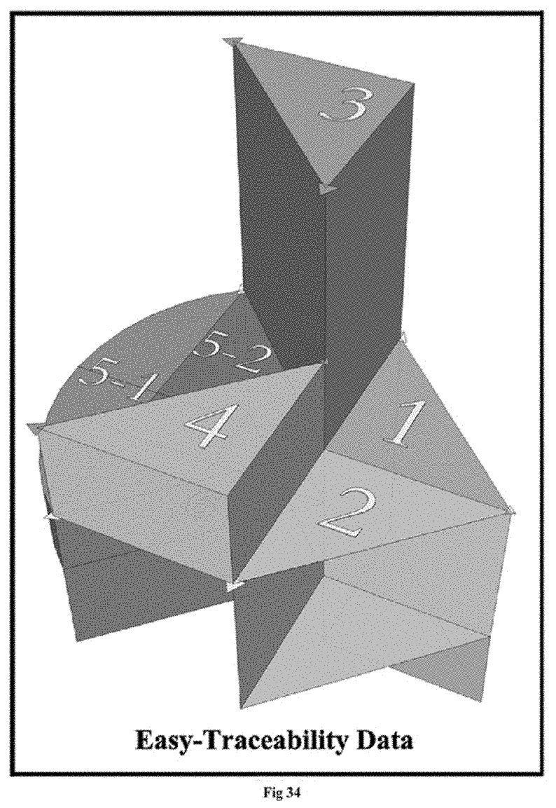

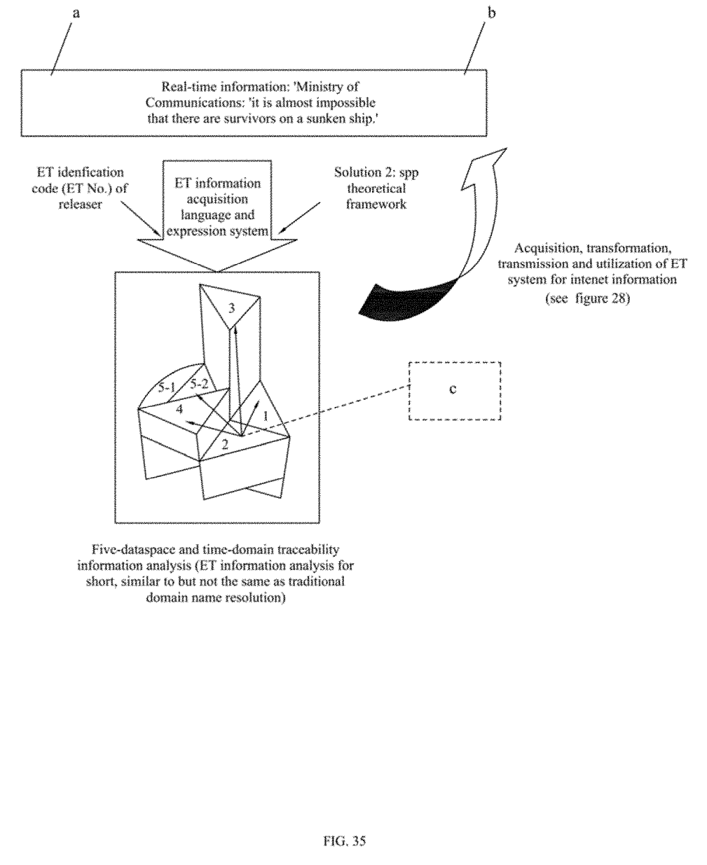

(12) An operation and maintenance management center is established for providing clerical work such as financial, business and daily operation management and logistical support and the like, for example, a visual identification system of a design company (as shown in FIG. 33: an ET number mark) and the project planning management center commonly develop an ‘information authentication’ project, a functional form of the project may be that: an ET conceptual model is designed into an ET information authentication mark model (as shown in FIG. 34, called an ET authentication mark for short) and is taken as a link access of a user for viewing detailed authentication information on the internet, a certain graphic feature is endowed to the visual identification system of the company to form an ET number mark, the ET number mark is combined with the ET authentication mark, so as to provide visualization, differentiation and permission functional requirements for information demanders and realize isolation, definition and limitation of information of an interne page, a media page, a physical media and the like, so as to carry out ET information authentication on network information; in the ET information authentication, an ET analysis is carried out on the network information by the ET information acquisition language and expression system, information data are stored, analyzed and processed by a special passageway of the ET system and are transmitted to client information (ET application level information), and a function effect diagram is shown in FIG. 35. As shown in FIG. 35, a is an ET idenfication code (ET No.) of releaser; b represents that the diagram showing a query link (entrance) for ET authentication of detailed data of the information; c represents that a man of the information is some officer of Ministry of Communications, the opposite side of the evaluation is some characteristic (i.e., the number of affected people) of accident severity of a product, and therefore, the ET analysis (an ET pointing analysis solution) on the information is described as follows: qh: ship sinking accident; PgA@: severity—the number of affected people of ship sinking accident; goods dataspace: the number of affected people; men dataspace: some officer of Ministry of Communications; production dataspace: NA; process dataspace: rebroadcasting of media (since a product or a goods is news information, and a process is words of a rebroadcasting officer, a dot matrix of the process dataspace is the geographical position of a journalist; and influence factors of the reporting process of the journalist can be stored and recorded by an ET model dimension page if a plurality of journalists rebroadcast simultaneously at the moment (theoretically, the possibility does not exist, otherwise the journalists are pregnant, there is an evidence to prove that a fetus generates a similar perception, or a cross space coordinate is established in an ET five-dataspace model space to isolate information of the model when the GIS position of a system appears deviation or time service appears deviation.)). System dataspace: 5-1: ***ship; 5-2: the number of actually carried people passing through the surface of some river at some moment.

For the major proposal after the Wenchuan earthquake, the project planning management center assigns the following tasks to all departments and sections:

(1) The Process Influence Research Department

A health management research team is established; and

Representation effects of body temperature on human health are collected and proved, and the following questions are output, such as which processes influence the body temperature (for example, after a cotton-padded jacket is worn, and after a lunch is had)? Whether the body temperature is acquired respectively from the angle of ages? Which evaluation threshold value is set for designing an acquisition interface for the ET information? Which type of time-domain information needs to close attention? Are professions, working environments and sexes the main factors influencing the process when the body temperature of men is, acquired (far example, it is proposed that ‘disaster victims possibly feel increased body temperature generally when passing by the periphery of a landslide dam’, so information elements near the landslide darn are marked and comparatively analyzed)? Which information acquisition is conductive to removal of distorted or unexpected data?

(2) The Macroscopic Quality Research Department

Which external co-factors are conductive to monitoring of change of the body, temperature? w rich degree that the body temperature of a baby is higher than can cause cry and shout of the baby?

(3) The Correlation Mathematics Research Dpartment

The early-warning element research laboratory: a cultural and physical environment research team is established and is responsible far collecting which PaAs@ also should be monitored to assist to analyze the external environment factors influencing the change of the body temperature (for example, whether a situation that the body temperature of people in the disaster area is generally raised due to fear and panic within half an hour after bearing a thunder possibly exists);

The ET information analysis research laboratory; the ET information analysis research laboratory is combined with the early-warning element research laboratory to search the information such as the activity conditions of toads or other animals and plants in the surrounding areas and within the China region in the recent, period by the ET information system; and whether it should be considered that the body temperature of residents in cities with the same climatic environment for comparative analysis?

(4) The Information Acquisition Language and Expression Research Department

The department is cooperated with the research & development and manufacturing center of the intelligent detection sensor to research the following questions: which technical solution should be taken for acquisition of the body temperature? Which one should be adopted from measurement-type data or counting-type data? Which object or which situation is the measurement-type data or the counting-type data suitable for? Which frequentness or threshold level are babies, middle-aged people and aged people suitable for in the acquisition?

(5) The Research & Development and Manufacturing Center of the Intelligent Detection Sensor

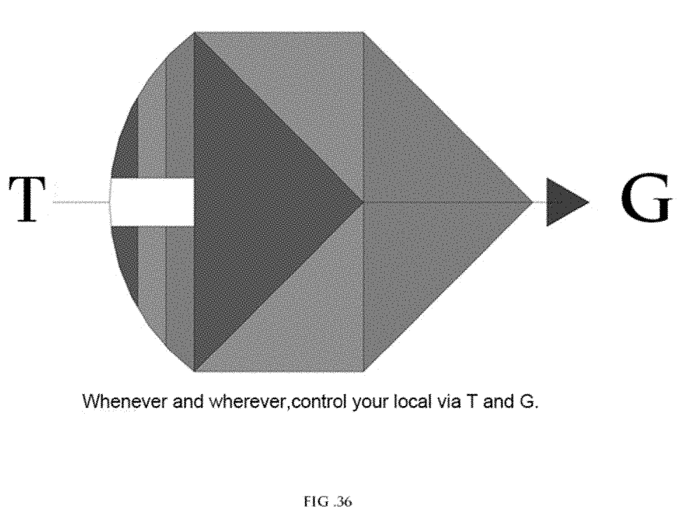

The high-reliability intelligent detection sensor is researched and designed, so as to meet the acquisition requirements of the ET information, such as technical parameters and manufacturing process indexes such as waterproofness, cruising ability and the like, a shape or a technical solution of the intelligent sensor shown in FIG. 36 is possibly adopted according to the requirements, wherein T represents time, G represents geography, and the figure simply explains a shape and a technical solution of a data acquisition sensor (an RFID label) based on an RFID technology.

Through the above deployment, the ET system monitors whole-time-domain dynamic body temperature data of 920,000 residents in Aba prefecture in 10 years (the data acquisition is based on voluntary joining of the residents), and the ET system carries out analysis processing on the information, so as to obtain a body temperature map of the residents in Aba prefecture, which is shown in FIG. 30 (FIG. 31 and FIG. 32 are partial enlarged views).

About an analysis on a monitoring mechanism of the project:

Since the process influence has great influence on the PgA@ (body temperature), the roughness of the information acquired only by time domain tracing is great, a fluctuation parameter of the process parameters needs to be added as an auxiliary information element, and the accuracy of the information acquired by the time domain tracing also should be enhanced in the acquisition process of the parameters of a process dataspace (for example, similarly, in a public toilet of a park, the body temperature of an aged man and a naked strong man who just runs back possibly have greater difference), therefore, in order to acquire more useful monitoring information, the system needs to develop a series of interfaces, an information acquisitor make corresponding supplement for the parameters of the process dataspace, so as to be conductive to fast and accurate searching and analysis of the system for decision information beneficial for an acquired person; and the acquisition for the ET information of the PgA@ needs to be realized by combining a gene axis horizontal tracing method and the per.dem of the process dataspace, so as to establish a traceability data warehouse. A PgA and the PgA@ are established in the actual geographical position in an X-Y-Z coordinate of the system, a time domain track of an individual, is recorded in an individual five-dataspace model, and the system generates a change track on an X-Z plane due to the dynamic deviation generated by the parameters of the process dataspace (particularly due to data overlapping generated by altitude, the system establishes the model in a space corresponding to a Z axis). A five-dataspace model array of an X-Y plane of the system reflects geographical positions of all PgAs (geographical positions when every person year triggers and accesses the parameter of the body temperature at the first time), and a single PgA model can be mapped onto the X-Y plane by an interactive mapping technology of the system.

What is claimed is:

1. A quality perception information management method:
the technical principle of the method is a single quality characteristic acquisition mode which comprises a single quality characteristic acquisition mode based on an spp (system, process and production) theoretical framework, a single quality characteristic acquisition mode based on a demand management theory and a single quality characteristic acquisition mode based on demand conditions of an artificially designed object to dynamic parameters or restriction factors of the artificially designed object; and
the spp theoretical framework refers to abbreviations of system, process and production and is translated into the system, the process and the production; the spp theoretical framework has the application features that when a business flow is converted to an information flow, a data source is collected, quantified and acquired based on three layers of the system, the process and the production;
the perception is defined as some triggering and effects thereof of biological cells/organs to external parameters, capturing, quantification and record of dynamic/static parameters by people by virtue of a physical measurement and control method, or mutual measurement of a degree that some demand parameter of the object is satisfied;
the quality perception is a combination of evaluation on perception with a judgement criterion, capturing of some triggering signal by brain/organ and effect reflection thereof and perception of the object to dynamic parameter quantification data set based on quality characteristic theory, demand theory or restriction theory logic;
the technical feature: the technical feature of the ET five domain model technical logic and parameters is based on three-dimensional evaluation and time domain traceability;
the three-dimensional evaluation has the following features of the evaluation features of a product layer, a process layer and a system layer in the quality management field and graphical three-dimensional intuitive evaluation features of information record, information processing/analysis, information transmission application and information audience in the informatization field;
the time domain traceability has the following features: collection of information based on time and geographic location, acquisition or analog-digital conversion/digital-analog conversion of the information based on time and geographic location, storage of the information based on time and geographic location, comprising modulation and demodulation or storage processing of data information, and analysis utilization of information based on time and geographic location, comprising mathematical processing analysis/propagation application/audience application;
the ET five domain model technical logic and parameter shave the following features: the feature of having a vector arrow axis to represent some quality characteristic or some perception and having five dot matrix data domains, each of which has the color feature, the latitude and longitude arrangement feature of geological spatial location, the feature of integration layer varying along with time, the distribution feature and the posture feature in a three-dimensional rectangular coordinate system and the feature that point matrices among data domains and point matrices among data domains in each model are connected with one another through vector arrows to represent corresponding business logic relationships, the ET five domain technical logic and parameters comprise ET five domain technical conceptual model and parameters, ET five domain logic model and parameters and ET physical model and parameters;
according to the ET five domain model, ET refers to abbreviation of Easy-Traceability and is translated to easiness in traceability;
the feature of the integration layer varying along with the time comprises:
1: commodity domain, expressed as
$${\int }_{0}^{+ ∞} [ {\sum }_{1}^{n} ( xNS 1 , yWE 1 ) ( t ( {good}^{’} ) ] ( t ( good ) ) ;$$
2: evaluation main body domain, expressed as:
$${\int }_{0}^{+ ∞} [ {\sum }_{1}^{n} ( xNS 2 , yWE 2 ) ( t ( {men}^{’} ) ] ( t ( men ) ) ;$$
3: product domain, expressed as:
$${\int }_{0}^{+ ∞} [ {\sum }_{1}^{n} ( xNS 3 , yWE 3 ) ( t ( {product}^{’} ) ] ( t ( product ) ) ;$$
4: process domain, expressed as:
$${\int }_{0}^{+ ∞} [ {\sum }_{1}^{n} ( xNS 4 , yWE 4 ) ( t ( {pr}^{’} ) ] ( t ( pr ) ) ;$$
5: extensive system domain, expressed as:
$${\int }_{0}^{+ ∞} [ {\sum }_{1}^{n} ( xNS 5 , yWE 5 ) ( t ( {s}^{’} ) ] ( t ( syste m ) ) ;$$
5-1: extensive system domain-performance subdomain;
5-2: extensive system domain-purpose subdomain;
Tg′A: commodity domain time differential axis;
Tm′A: evaluation main body time differential axis;
Tp′A: product domain time differential axis;
Tpr′A: process domain time differential axis;
Ts′A: extensive system domain time differential axis;
TgA: commodity domain time axis;
TmA: evaluation main body time axis;
TpA: product domain time axis;
TprA: process domain time axis;
TsA: extensive system domain time axis;
WE1: longitude coordinate of commodity;
NS1: latitude coordinate of commodity;
WE2: longitude coordinate of evaluation main body;
NS2: latitude coordinate of evaluation main body;
WE3: longitude coordinate of product;
NS3: latitude coordinate of product;
WE4: longitude coordinate of process;
NS4: latitude coordinate of process;
WE5: longitude coordinate of extensive system;
NS5: latitude coordinate of extensive system;
PgA@: perception gene axis symbol, also called product gene axis;
PgA: initial product gene axis;
Qh: information host symbol, also called quality host;
Ih: information donor symbol;
Rh: information acceptor symbol;
Ea: evaluation axis symbol;
base coordinate axis system: X axis, Y axis and Z axis;
the distribution feature and the posture feature in the three-dimensional rectangular coordinate system comprises an ET five domain model set array rule, model axial shuddering coefficients, model horizontal shuddering coefficients, model vertical shuddering coefficients, an ET five domain designation interface, an ET information collection and expression rule, an ET evaluation dimension display logic, an ET information acquisition and measurement rule, an ET evaluation dimension graphical display logic rule, an ET early-warning member function curve, ET perception strength, ET breakdown effect, an ET searchlighting comparison technology, an ET perspective analysis method, an ET colour space and an ET lotus diagram;
the ET five domain model set array rule comprises a cause-and-effect traceability main axis, a collaborative traceability main axis, a perception traceability main axis, a collaborative gene axis and a five-domain collaborative axis;
application features: applying above method to collect, acquire, store/classify, process, analyze, transmit and apply quality perception information, and one or more links in useful decision/demand information is formed, and the method comprises the following steps:
step 1: a method of perceiving quality based on three-dimensional evaluation and time domain traceability;
step 2: a method of converting quality perception to information based on three-dimensional evaluation and time domain traceability;
step 3: a method of measuring and recording quality perception information based on three-dimensional evaluation and time domain traceability;
step 4: a method of storing perception information or a method of constructing a storage system based on three-dimensional evaluation and time domain traceability;
step 5: a method of enabling recognized and collected information to be objective and accurate based on three-dimensional evaluation and time domain traceability;
step 6: a method of converting the stored perception information to useful information based on three-dimensional evaluation and time domain traceability;
step 7: a method of collecting the useful information based on three-dimensional evaluation and time domain traceability;
step 8: a method of capturing a perception tendency based on three-dimensional evaluation and time domain traceability;
step 9: a method of speculating connections among things by statistically analyzing the information based on three-dimensional evaluation and time domain traceability; and
step 10: a method of speculating connections among things by statistically analyzing the perception tendency based on three-dimensional evaluation and time domain traceability.

2. The method of perceiving the quality based on three-dimensional evaluation and time domain traceability according to claim 1, comprising a method of applying the single quantity characteristic acquisition mode and the ET five domain technical model technical logic and parameters to perceive the quality.

3. The method of converting quantity perception to the information based on three-dimensional evaluation and time domain traceability according to claim 1, comprising a method of applying the ET five domain technical model technical logic and parameters to convert the quantity perception to the information.

4. The method of measuring and recording the quantity perception information based on three-dimensional evaluation and time domain traceability according to claim 1, comprising the following steps: applying the ET information collection and measurement rule to measure the information; applying the spp theoretical framework to collect, record, transmit or utilize the quality perception information, comprising applying an information donor, an information acceptor or a triangular structure with the time domain traceability logic to corresponding terminal acquisition software or terminal hardware to carry out informatization management or advertisement or to search engine software, social software, a commerce information website and a platform to carry out audience propagation utilization on the quality perception information; and applying the ET five domain logic model and parameters or a technical scheme thereof to store, process and analyze the collected information.

5. The method of storing the perception information or a method of constructing the storage system based on three-dimensional evaluation and time domain traceability according to claim 1, comprising the following steps: applying the ET five domain conceptual model and parameters or a technical scheme thereof to graph record and recognition; applying the ET five domain logic model and parameters or a technical scheme thereof to converting the information to data and carrying out structured storage and analysis on large-scale data, comprising designing a cloud storage architecture; applying the ET physical model and parameters or a technical scheme thereof to data storage physical structure design, a physical storage medium, a physical display medium, a visible physical structural body, comprising design, production or application of a building material or a ground pavement material, and communication transmission utilization of a physical port command, a connection standard or connection communication software and data or information, comprising design purposes of wireless communication transmission utilization or a transmission standard/protocol;
the structured storage analysis comprises physical model design for data information, design engaging in a database or a software architecture and design or scheme used for acceleration information storage, processing and analysis in the related field, comprising utilizing the related logic or data structures or derivative technical schemes thereof of the ET searchlighting comparison technology, the ET breakdown effect, the ET perception strength analysis, the ET early-warning member function curve analysis method, the ET perspective analysis method to design or manufacture an information/data/graphical information processor or to design or manufacture an information/data computational tool or software; and
the production comprises an etching and forming process of a semiconductor/electronic material/memory material.

6. The method of converting the stored perception information to the useful information based on three-dimensional evaluation and time domain traceability according to claim 1, comprising a method of applying the spp theoretical framework or a technical scheme thereof to classify, tidy, propagate and utilize the information; and a method of applying the ET five domain model set array rule and parameters or a technical scheme thereof to detect, verify and analyze the data information.

7. The method of converting the stored perception information to the useful information based on three-dimensional evaluation and time domain traceability according to claim 1, comprising a method of applying the ET early-warning member function curve, the ET perception strength, the ET breakdown effect and the ET searchlighting comparison technology or a logic or technical scheme thereof, the model axial shuddering coefficients, the model horizontal shuddering coefficients and the model vertical shuddering coefficients to process and analyze the information.

8. The method of collecting the useful information demands based on three-dimensional evaluation and time domain traceability according to claim 1, comprising a method of applying the ET five domain designation interface to carry out information acquisition transmission; and a method of applying time axis or regional axis parameters of the ET five domain model or a technical scheme thereof, the model axial shuddering coefficients, the model horizontal shuddering coefficients and the model vertical shuddering coefficients to trace, recognize and judge the things and carry out macroscopic detection and early warning on the things and the characteristics.

9. The method of collecting the useful information demands based on three-dimensional evaluation and time domain traceability according to claim 1, comprising a method of applying the ET early-warning member function curve, the ET perception strength, the ET breakdown effect, the ETsearchlighting comparison technology, the ET colour space, the ET lotus diagram or a logic or the technical scheme thereof to mine information.

10. The method of speculating the connections among the things by statistically analyzing the information based on three-dimensional evaluation and time domain traceability according to claim 1, comprising a method of applying the ET five domain model technical logic and parameters to statistically analyze the information and/or speculate the connections among the things.

11. The method of speculating the connections among the things by statistically analyzing the perception tendency based on three-dimensional evaluation and time domain traceability according to claim 1, comprising a method of applying the ET five domain model technical logic and parameters to carry out direct/indirect data information mining on the data information.

12. Symbols, terms, graphs and expression forms described in the description constitute a part of the present invention, for example, ET number marks, ET certification marks, Tand G intelligent sensor information acquisition scheme diagrams and relative graphs or technical schemes are applied to the condition that Internet pages, communications media or other physical media carry out information acquisition, certification or management.
